(19) United States
(12) Patent Application Publication
(10) Pub. No.: US 2025/0202604 A1
(43) Pub. Date: Jun. 19, 2025

(54) NR RELAYS- METHODS FOR MULTI-PATH DISCOVERY, RELAY SELECTION, AND NETWORK REPORTING

(71) Applicant: InterDigital Patent Holdings, Inc., Wilmington, DE (US)

(72) Inventors: Tuong Hoang, Montreal (CA); Martino Freda, Laval (CA); Ananth Kini, Conshohocken, PA (US); Oumer Teyeb, Montreal (CA)

(73) Assignee: InterDigital Patent Holdings, Inc., Wilmington, DE (US)

(21) Appl. No.: 18/847,965

(22) PCT Filed: Mar. 30, 2023
(86) PCT No.: PCT/US2023/016944

§ 371 Date: Sep. 17, 2024

Related U.S. Application Data
(60) Provisional application No. 63/327,578, filed on Apr. 5, 2022.
(60) Provisional application No. 63/410,817, filed on Sep. 28, 2022.
(60) Provisional application No. 63/445,332, filed on Feb. 14, 2023.

(51) Int. Cl. H04B 17/318; H04W 40/24; H04W 72/25

(52) U.S. Cl. CPC H04B 17/328; H04W 40/246; H04W 72/25

(57) ABSTRACT

A wireless transmit/receive unit (WTRU) may receive configuration information that may indicate one or more parameters for operating as a WTRU-to-network mobile relay. The parameters may include a first reference signal power (RSRP) threshold and/or a second RSRP threshold. The WTRU may perform an RSRP measurement of a serving cell to determine an RSRP value. The WTRU may determine whether to indicate support for one or more of a single-path operation and a multi-path operation in a sidelink discovery message based on the RSRP value. The WTRU may indicate support for the multi-path relay operation based on the RSRP value satisfying the second RSRP threshold. The WTRU may indicate support for the single-path relay operation based on the RSRP value satisfying the first RSRP threshold. The WTRU may transmit a sidelink discovery message indicating support for a single-path relay operation and/or a multi-path relay operation based on the RSRP value.

### CROSS-REFERENCE TO RELATED APPLICATIONS

This application claims the benefit of U.S. Provisional Patent Application No. 63/327,578, filed on Apr. 5, 2022, U.S. Provisional Patent Application No. 63/410,817, filed on Sep. 28, 2022, and to U.S. Provisional Patent Application No. 63/445,332, filed on Feb. 14, 2023, the entire contents of which are incorporated herein by reference.

### BACKGROUND

New Radio (NR) sidelink relay may be performed. For example, wireless transmit/receive unit (WTRU)-to-network (W2N) relays and/or WTRU-to-WTRU (W2 W) relays may be used based on PC5 (e.g., sidelink).

NR sidelink may focus on supporting vehicular communications (V2X)-related road safety services. For example, support may be provided for broadcast, groupcast, and/or unicast communications in both out-of-coverage and in-network coverage scenarios. Sidelink-based relaying functionality may be studied in order to extend sidelink/network coverage and improve power efficiency, considering a wider range of applications and services.

W2N coverage may be extended. Uu coverage reachability may be useful for WTRUs to reach a server in a PDN network or a counterpart WTRU outside of a proximity area. However, current solutions for W2N relays may be limited to EUTRA-based technologies, and therefore may not be able to be applied to an NR-based system, for both NG-RAN and NR-based sidelink communication.

W2 W coverage may be extended. Proximity reachability may be limited to single-hop sidelink link, either via EUTRA-based or NR-based sidelink technology. However, this may not be sufficient in a scenario where there is no Uu coverage, considering the limited single-hop sidelink coverage. Sidelink connectivity may be extended further in an NR framework in order to support enhanced quality of service (QOS) requirements.

### SUMMARY

Discovery transmission may be performed. A WTRU may support and/or request one or more relay services. The WTRU may perform discovery-relay-service message transmission. The WTRU may receive (pre-) configuration for discovery-relay-service transmission. The WTRU may indicate to the network its supported relay service(s) capability. The WTRU may receive an indication from the network indicating a type of relay (e.g., which type of relay it should be). The WTRU may request resource(s) for discovery-relay-service transmission(s). The WTRU may perform transmission of a discovery-relay-service message. The WTRU may determine which discovery-relay-service message to transmit. The WTRU may determine the quality of service (QOS) associated with the discovery-relay-service message. The WTRU may determine the resource pool to transmit a discovery-relay-service message. The WTRU may determine the transmission parameters of a discovery-relay-service message. The WTRU may determine the information to include in a discovery message.

Relay selection may be performed. The WTRU may trigger relay selection. The WTRU may determine which relay to (re) select. The WTRU may determine whether to perform relay reselection and/or report the set of detected relays to the network.

The WTRU may report a set of detected Remote WTRUs and/or a set of detected relays. The WTRU may request a resource for a discovery-relay-service transmission. The WTRU may receive an indication to transmit a discovery-relay-service message. The WTRU may trigger cell reselection. The WTRU may determine which cell to prioritize/report.

In an example, a WTRU (e.g., a Relay WTRU) may determine one or more of which discovery-relay-service message to transmit, one or more discovery transmission parameters, and a resource pool to transmit the discovery message based on Uu reference signal receive power (RSRP), a relay load, and/or the WTRU relay capability.

For example, the WTRU may be (pre-) configured with conditions to transmit multi-path and/or single-path discovery message (e.g., via dedicated RRC or SIB). Alternatively, or additionally, the WTRU may receive conditions to transmit multi-path and/or single-path discovery message (e.g., via dedicated RRC or SIB). The discovery message may include one or more of a Uu RSRP range (e.g., minimum and maximum Uu RSRP) for single-path discovery, a (e.g., different) minimum Uu RSRP for multi-path discovery, a relay capability (e.g., which may include support for single-path and/or multi-path relay), and/or the quality of service (QOS) (e.g., priority) and transmission resource pool for one or more (e.g., each) type of discovery message. The WTRU may determine which type of discovery message to transmit based on one or more of its measured Uu RSRP, relay load, and the WTRU capability to support multi-path and/or single-path relay. In an example, the WTRU may be allowed to transmit single-path discovery (e.g., only) for high-load cases (e.g., network extension may be prioritized). The WTRU may select a resource pool to transmit the discovery message based on the discovery type. The WTRU may use the (pre-) configured QoS of the discovery message to determine the transmission parameters of the discovery message. The WTRU may indicate one or more of the discovery type (e.g., single-path and/or multi-path), the Uu RSRP (e.g., for the Remote WTRU to perform relay selection), and/or the QoS of the discovery message in the discovery message. The WTRU may perform discovery transmission.

In an example, a WTRU (e.g., a Remote WTRU) may determine whether to transmit single-path and/or multi-path discovery based on one or more of its measured Uu RSRP, the reception of SLRB/LCH configuration for multi-path, and/or the arrival data from a set of SLRBs/LCHs in the buffer. Upon transmission of multi-path discovery, the WTRU may select/report (e.g., to a gNB) the set of relays supporting multi-path and having appropriate Uu RSRP.

For example, a WTRU (e.g., a Remote WTRU) may be (pre-) configured with or may receive conditions (e.g., via dedicated RRC or SIB) to transmit a discovery message. The discovery message may include one or more of a maximum Uu RSRP for single-path discovery, a range of Uu RSRP (e.g., a minimum and (e.g., different) maximum Uu RSRP) for multi-path discovery, a set of SLRBs/LCHs to trigger multi-path discovery, and/or the minimum Uu RSRP of the relay per SLRB/LCH. The WTRU may perform one or more of the following: upon reception of SLRBs/LCHs configuration and/or the arrival of SLRBs/LCHs data which satisfies the configured conditions for multipath relay, trigger discovery transmission; perform relay response receptions; and/or perform relay selection or select the set of relays to inform the network, which satisfy the following conditions: supporting multi-path; supporting the established SLRB/LCH; and Uu RSRP of the relay is higher than a threshold, which may be based on the SLRB/LCH of the Remote WTRU. For example, if the Uu threshold for transmission of single-path is not satisfied, but the threshold for multi-path discovery is satisfied, the WTRU may perform one or more of the following: upon reception of SLRBs/LCHs configuration and/or the arrival of SLRBs/LCHs data which satisfies the configured conditions for multipath relay, trigger discovery transmission; perform relay response receptions; and/or perform relay selection or select the set of relays to inform the network, which satisfy the following conditions: supporting multi-path; supporting the established SLRB/LCH; and Uu RSRP of the relay is higher than a threshold, which may be based on the SLRB/LCH of the Remote WTRU.

The Relay WTRU may determine which set of detected Remote WTRUs to report to the network. Additionally, or alternatively, the WTRU (e.g. Relay WTRU) may determine which set of detected relays to report to the network. The Relay WTRU may indicate (e.g., transmit) information in a discovery message. The Remote WTRU may indicate (e.g., transmit) its Uu connection status in a discovery-service message. A WTRU may determine to transmit the discovery-relay-service message. A WTRU may determine whether a cell supports one or more relay services. A WTRU may determine whether to transmit a discovery-relay-service message based on an indication from the cell. A WTRU may determine whether to respond (e.g., transmit) to a Remote WTRU. A WTRU may determine its load.

A WTRU (e.g., first WTRU) may monitor for one or more discovery messages. The one or more discovery messages may be from one or more second WTRUs. The WTRU may determine a set of the one or more second WTRUs, for example based on the discovery messages. The WTRU may report the set of the one or more second WTRUs, for example to a network. The set of the one of more second WTRUs may be based on a support type. The support type may include one or more of single-path service and multi-path service. The WTRU may compare a second WTRU reference signal received power (RSRP) to a threshold. The WTRU may determine the support type based on the comparison of the second WTRU RSRP to the threshold. For example, the WTRU may determine that the support type is single-path service if the second WTRU RSRP is less than the threshold. In another example, the WTRU may determine that the support type is single-path service if the second WTRU RSRP is less than the threshold. The WTRU may determine the support type based on a connection status of a second WTRU. The WTRU may compare a second WTRU quality of service (QOS) to a threshold.

A WTRU (e.g., Relay WTRU) may receive configuration information. The configuration information may indicate one or more parameters. The one or more parameters may be for operating as a WTRU-to-network mobile relay. Additionally, or alternatively, the parameters may include a first reference signal power (RSRP) threshold and/or a second RSRP threshold.

The WTRU may perform an RSRP measurement, for example to determine an RSRP value. For example, the WTRU may receive a signal from the network (e.g., a serving cell of the network), and may perform the RSRP measurement on the received signal. The WTRU may determine whether to indicate support for one or more of a single-path operation and a multi-path operation. The WTRU may determine whether to indicate support for one or more of a single-path operation and a multi-path operation in a sidelink discovery message, for example based on the RSRP value. The WTRU may indicate support for the multi-path relay operation based on the RSRP value satisfying the second RSRP threshold. Additionally, or alternatively, the WTRU may indicate support for the single-path relay operation based on the RSRP value satisfying the first RSRP threshold. The WTRU may transmit the sidelink discovery message, for example indicating support for one or more of a single-path relay operation and a multi-path relay operation. For example, the WTRU may transmit the sidelink discovery message indicating support for one or more of a single-path relay operation and a multi-path relay operation based on the RSRP value.

The parameters may include a relay load range. The WTRU may indicate support for the multi-path relay operation based on a current relay load of the WTRU, for example being less than a relay load range. The parameters may include an indication of a first resource pool and/or an indication of a second resource pool. The first resource pool may be for transmitting a first sidelink discovery message, for example that indicates support for the single-path relay operation. The second resource pool may be for transmitting a second sidelink discovery message, for example that indicates support for the multi-path relay operation. The sidelink discovery message may indicate the RSRP value. The WTRU may indicate support for the single-path relay operation when the RSRP value is greater than or equal to the first RSRP threshold. Additionally, or alternatively, the WTRU may indicate support for the single-path relay operation when the RSRP value is less than the second RSRP threshold.

The WTRU may indicate support for the multi-path relay operation when the RSRP value is greater than or equal to the second RSRP threshold. The WTRU may transmit a report to a network, for example based on the RSRP value. The report may indicate one or more second WTRUs. For example, the report may indicate one or more second WTRUs requesting the single-path relay operation when the RSRP value satisfies the first RSRP threshold. Additionally, or alternatively, the report may indicate one or more second WTRUs requesting the multi-path relay operation when the RSRP value satisfies the second RSRP threshold.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example user plane radio protocol stack for an L2 evolved WTRU-to-Network relay (e.g., PC5);

FIG. 3 illustrates an example control plane radio protocol stack for an L2 evolved WTRU-to-Network relay (e.g., PC5);

FIG. 4 illustrates an example of a WTRU determining whether to transmit single-path discovery vs. multipath discovery and single-path solicitation vs. multipath solicitation; and

FIG. 5 illustrates an example of a Remote WTRU prioritizing the Relay WTRU associated with the gNB having measured Uu RSRP being greater than or equal to a threshold; and

FIG. 6 illustrates an example of a Relay WTRU determining whether to transmit single-path discovery vs. multipath discovery based on measured Uu RSRP being greater than or equal to a threshold.

### EXAMPLE NETWORKS FOR IMPLEMENTATION OF THE INVENTION

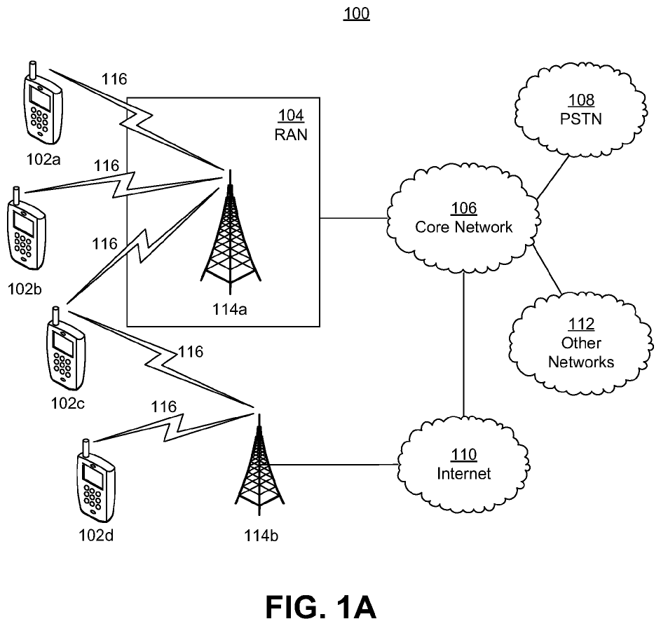

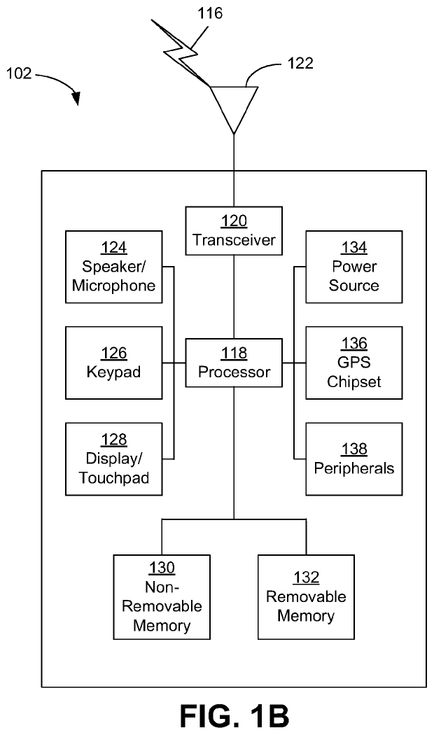

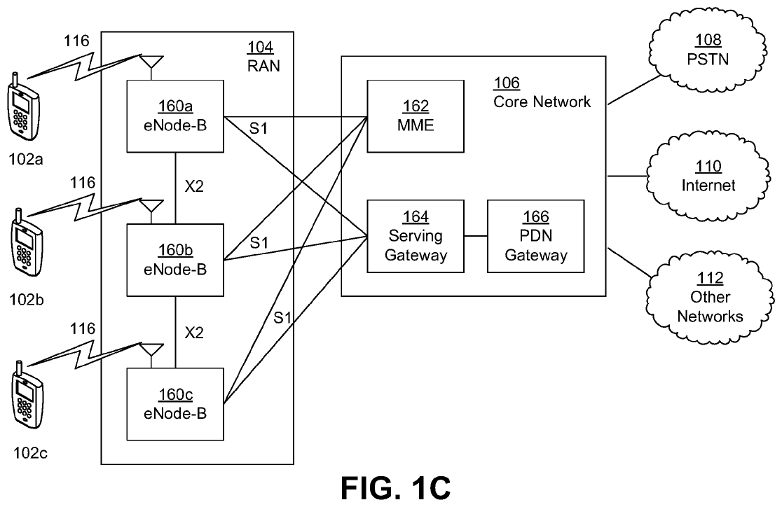

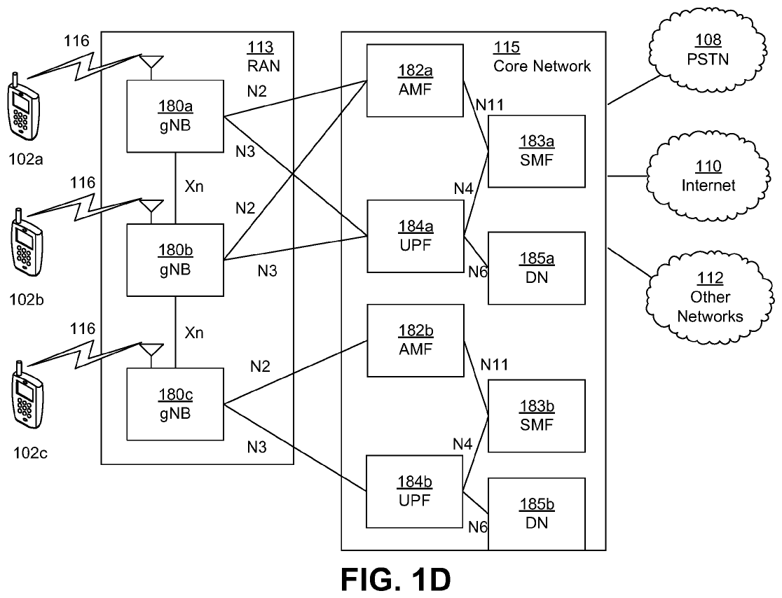

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network.

The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Discovery transmission may be performed. A WTRU may support and/or request one or more relay services. The WTRU may perform discovery-relay-service message transmission. The WTRU may receive (pre-) configuration for discovery-relay-service transmission. The WTRU may indicate to the network its supported relay service(s) capability. The WTRU may receive an indication from the network indicating a type of relay (e.g., which type of relay it should be). The WTRU may request resource(s) for discovery-relay-service transmission(s). The WTRU may perform transmission of a discovery-relay-service message. The WTRU may determine which discovery-relay-service message to transmit. The WTRU may determine the quality of service (QOS) associated with the discovery-relay-service message. The WTRU may determine the resource pool to transmit a discovery-relay-service message. The WTRU may determine the transmission parameters of a discovery-relay-service message. The WTRU may determine the information to include in a discovery message.

Relay selection may be performed. The WTRU may trigger relay selection. The WTRU may determine which relay to (re) select. The WTRU may determine whether to perform relay reselection and/or report the set of detected relays to the network.

The WTRU may report a set of detected Remote WTRUs and/or a set of detected relays. The WTRU may request a resource for a discovery-relay-service transmission. The WTRU may receive an indication to transmit a discovery-relay-service message. The WTRU may trigger cell reselection. The WTRU may determine which cell to prioritize/report.

In an example, a WTRU (e.g., a Relay WTRU) may determine one or more of which discovery-relay-service message to transmit, one or more discovery transmission parameters, and a resource pool to transmit the discovery message based on Uu reference signal receive power (RSRP), a relay load, and/or the WTRU relay capability.

For example, the WTRU may be (pre-) configured with conditions to transmit multi-path and/or single-path discovery message (e.g., via dedicated RRC or SIB). Alternatively, or additionally, the WTRU may receive conditions to transmit multi-path and/or single-path discovery message (e.g., via dedicated RRC or SIB). The discovery message may include one or more of a Uu RSRP range (e.g., minimum and maximum Uu RSRP) for single-path discovery, a (e.g., different) minimum Uu RSRP for multi-path discovery, a relay capability (e.g., which may include support for single-path and/or multi-path relay), and/or the quality of service (QOS) (e.g., priority) and transmission resource pool for one or more (e.g., each) type of discovery message. The WTRU may determine which type of discovery message to transmit based on one or more of its measured Uu RSRP, relay load, and the WTRU capability to support multi-path and/or single-path relay. In an example, the WTRU may be allowed to transmit single-path discovery (e.g., only) for high-load cases (e.g., network extension may be prioritized). The WTRU may select a resource pool to transmit the discovery message based on the discovery type. The WTRU may use the (pre-) configured QoS of the discovery message to determine the transmission parameters of the discovery message. The WTRU may indicate one or more of the discovery type (e.g., single-path and/or multi-path), the Uu RSRP (e.g., for the Remote WTRU to perform relay selection), and/or the QoS of the discovery message in the discovery message. The WTRU may perform discovery transmission.

In an example, a WTRU (e.g., a Remote WTRU) may determine whether to transmit single-path and/or multi-path discovery based on one or more of its measured Uu RSRP, the reception of SLRB/LCH configuration for multi-path, and/or the arrival data from a set of SLRBs/LCHs in the buffer. Upon transmission of multi-path discovery, the WTRU may select/report (e.g., to a gNB) the set of relays supporting multi-path and having appropriate Uu RSRP.

For example, a WTRU (e.g., a Remote WTRU) may be (pre-) configured with or may receive conditions (e.g., via dedicated RRC or SIB) to transmit a discovery message. The discovery message may include one or more of a maximum Uu RSRP for single-path discovery, a range of Uu RSRP (e.g., a minimum and (e.g., different) maximum Uu RSRP) for multi-path discovery, a set of SLRBs/LCHs to trigger multi-path discovery, and/or the minimum Uu RSRP of the relay per SLRB/LCH. The WTRU may perform one or more of the following: upon reception of SLRBs/LCHs configuration and/or the arrival of SLRBs/LCHs data which satisfies the configured conditions for multipath relay, trigger discovery transmission; perform relay response receptions; and/or perform relay selection or select the set of relays to inform the network, which satisfy the following conditions: supporting multi-path; supporting the established SLRB/LCH; and Uu RSRP of the relay is higher than a threshold, which may be based on the SLRB/LCH of the Remote WTRU. For example, if the Uu threshold for transmission of single-path is not satisfied, but the threshold for multi-path discovery is satisfied, the WTRU may perform one or more of the following: upon reception of SLRBs/LCHs configuration and/or the arrival of SLRBs/LCHs data which satisfies the configured conditions for multipath relay, trigger discovery transmission; perform relay response receptions; and/or perform relay selection or select the set of relays to inform the network, which satisfy the following conditions: supporting multi-path; supporting the established SLRB/LCH; and Uu RSRP of the relay is higher than a threshold, which may be based on the SLRB/LCH of the Remote WTRU.

The Relay WTRU may determine which set of detected Remote WTRUs to report to the network. Additionally, or alternatively, the WTRU (e.g. Relay WTRU) may determine which set of detected relays to report to the network. The Relay WTRU may indicate (e.g., transmit) information in a discovery message. The Remote WTRU may indicate (e.g., transmit) its Uu connection status in a discovery-service message. A WTRU may determine to transmit the discovery-relay-service message. A WTRU may determine whether a cell supports one or more relay services. A WTRU may determine whether to transmit a discovery-relay-service message based on an indication from the cell. A WTRU may determine whether to respond (e.g., transmit) to a Remote WTRU. A WTRU may determine its load.

A WTRU (e.g., first WTRU) may monitor for one or more discovery messages. The one or more discovery messages may be from one or more second WTRUs. The WTRU may determine a set of the one or more second WTRUs, for example based on the discovery messages. The WTRU may report the set of the one or more second WTRUs, for example to a network. The set of the one of more second WTRUs may be based on a support type. The support type may include one or more of single-path service and multi-path service. The WTRU may compare a second WTRU reference signal received power (RSRP) to a threshold. The WTRU may determine the support type based on the comparison of the second WTRU RSRP to the threshold. For example, the WTRU may determine that the support type is single-path service if the second WTRU RSRP is less than the threshold. In another example, the WTRU may determine that the support type is single-path service if the second WTRU RSRP is less than the threshold. The WTRU may determine the support type based on a connection status of a second WTRU. The WTRU may compare a second WTRU quality of service (QOS) to a threshold.

A WTRU (e.g., Relay WTRU) may receive configuration information. The configuration information may indicate one or more parameters. The one or more parameters may be for operating as a WTRU-to-network mobile relay. Additionally, or alternatively, the parameters may include a first reference signal power (RSRP) threshold and/or a second RSRP threshold.

The WTRU may perform an RSRP measurement. The WTRU may perform an RSRP measurement of a serving cell, for example to determine an RSRP value. The WTRU may determine whether to indicate support for one or more of a single-path operation and a multi-path operation. The WTRU may determine whether to indicate support for one or more of a single-path operation and a multi-path operation in a sidelink discovery message, for example based on the RSRP value. The WTRU may indicate support for the multi-path relay operation based on the RSRP value satisfying the second RSRP threshold. Additionally, or alternatively, the WTRU may indicate support for the single-path relay operation based on the RSRP value satisfying the first RSRP threshold. The WTRU may transmit the sidelink discovery message, for example indicating support for one or more of a single-path relay operation and a multi-path relay operation. For example, the WTRU may transmit the sidelink discovery message indicating support for one or more of a single-path relay operation and a multi-path relay operation based on the RSRP value.

The parameters may include a relay load range. The WTRU may indicate support for the multi-path relay operation based on a current relay load of the WTRU, for example being less than a relay load range. The parameters may include an indication of a first resource pool and/or an indication of a second resource pool. The first resource pool may be for transmitting a first sidelink discovery message, for example that indicates support for the single-path relay operation. The second resource pool may be for transmitting a second sidelink discovery message, for example that indicates support for the multi-path relay operation. The sidelink discovery message may indicate the RSRP value. The WTRU may indicate support for the single-path relay operation when the RSRP value is greater than or equal to the first RSRP threshold. Additionally, or alternatively, the WTRU may indicate support for the single-path relay operation when the RSRP value is less than the second RSRP threshold.

The WTRU may indicate support for the multi-path relay operation when the RSRP value is greater than or equal to the second RSRP threshold. The WTRU may transmit a report to a network, for example based on the RSRP value. The report may indicate one or more second WTRUs. For example, the report may indicate one or more second WTRUs requesting the single-path relay operation when the RSRP value satisfies the first RSRP threshold. Additionally, or alternatively, the report may indicate one or more second WTRUs requesting the multi-path relay operation when the RSRP value satisfies the second RSRP threshold.

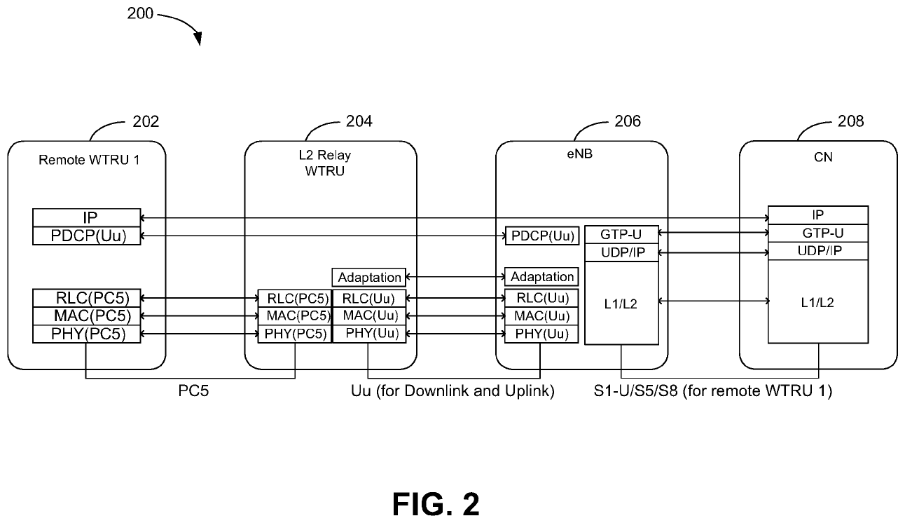

FIG. 2 illustrates an example system 200 illustrating a user plane radio protocol stack for an L2 evolved WTRU-to-Network relay (e.g., PC5). For example, FIG. 2 illustrates a Remote WTRU 202, an L2 Relay WTRU 204, an eNB 206 and a core network (CN) 208. A PC5 interface between the Remote WTRU 202 and L2 Relay WTRU 204 may be associated with (e.g., lower) layers, for example, including one or more of a physical layer (PHY), a MAC layer, and a radio link control (RLC) layer. A Uu interface between the L2 Relay WTRU 204 and eNB 206 may be associated with (e.g., lower) layers, for example, including one or more of an adaptation layer, a physical layer (PHY), a MAC layer, and a radio link control (RLC) layer. An interface (e.g., S1-U/S5/S8) between eNB 206 and CN 208 may be associated with L1/L2.

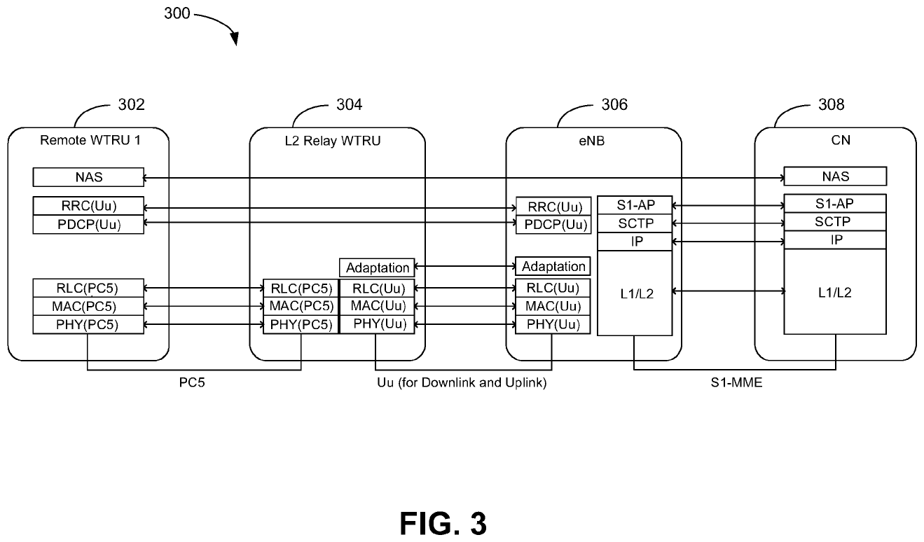

FIG. 3 illustrates an example system 300 illustrating a control plane radio protocol stack for an L2 evolved WTRU-to-Network relay (e.g., PC5). For example, FIG. 3 illustrates a Remote WTRU 302, an L2 Relay WTRU 304, an eNB 306 and a core network (CN) 308. A PC5 interface between the Remote WTRU 302 and L2 Relay WTRU 304 may be associated with (e.g., lower) layers, for example, including one or more of a physical layer (PHY), a MAC layer, and a radio link control (RLC) layer. A Uu interface between the L2 Relay WTRU 304 and eNB 306 may be associated with (e.g., lower) layers, for example, including one or more of an adaptation layer, a physical layer (PHY), a MAC layer, and a radio link control (RLC) layer. An interface (e.g., S1-MME) between eNB 306 and CN 308 may be associated with L1/L2.

A ProSe WTRU-to-network relay may perform relaying (e.g., be used as a relay). For example, a ProSe WTRU-to-network relay may be used as a relay to extend network coverage to an out-of-coverage WTRU by using PC5 (D2D) between an out-of-coverage WTRU and a WTRU-to-Network relay.

A ProSe WTRU-to-Network Relay may provide a forwarding function. For example, a ProSe WTRU-to-Network Relay may provide a generic L3 forwarding function. The forwarding function may relay any type of IP traffic between the Remote WTRU and the network. One-to-one and/or one-to-many sidelink communications may be sent between the Remote WTRU(s) and the ProSe WTRU-to-Network Relay. For a Remote WTRU and a Relay WTRU (e.g., only) one carrier (e.g., Public Safety ProSe Carrier) operation may be supported (e.g., Uu and PC5 should be the same carrier for Relay/Remote WTRUs). The Remote WTRU may be authorized. For example, the Remote WTRU may be authorized by one or more upper layers. Alternatively, or additionally, the Remote WTRU may be in-coverage of the Public Safety ProSe Carrier and/or out-of-coverage on any supported carriers including Public Safety ProSe Carrier for WTRU-to-Network Relay discovery, (re) selection and/or communication. The ProSe WTRU-to-Network Relay may (e.g., always) be in-coverage of EUTRAN. The ProSe WTRU-to-Network Relay and the Remote WTRU may perform sidelink communication and/or sidelink discovery as described in one or more specifications.

Relay selection for WTRU-to-network relays may be performed. For example, relay selection/reselection for ProSe WTRU-to-network relays may be performed. Relay selection may be based on one or more of AS layer quality measurements (RSRP) and/or upper layer criteria. For example, an eNB may control whether the WTRU may be a ProSe WTRU-to-network relay. ProSe WTRU-to-network relay operation(s) may be supported in the cell. For example, if the eNB broadcasts (e.g., any) information associated with ProSe WTRU-to-network relay operation, then ProSe WTRU-to-network relay operation may be supported in the cell. The eNB may provide transmission resources. The transmission resources may be for ProSe WTRU-to-network relay discovery. Additionally, or alternatively, the transmission resources may use broadcast signaling for RRC_IDLE state and/or dedicated signaling for RRC_CONNECTED state, and/or reception resources for ProSe WTRU-to-network relay discovery using broadcast signaling.

The eNB may broadcast a minimum and/or a maximum Uu link quality (RSRP) threshold(s). The minimum and/or a maximum Uu link quality (RSRP) threshold(s) may be threshold(s) that the ProSe WTRU-to-Network Relay may meet before initiating a WTRU-to-Network Relay discovery procedure. The WTRU may use the threshold(s) to autonomously start and/or stop the WTRU-to-Network Relay discovery procedure. For example, in RRC_IDLE, when the eNB broadcasts transmission resource pools, the WTRU may use the threshold(s) to autonomously start and/or stop the WTRU-to-Network Relay discovery procedure. The WTRU may use the threshold(s) to determine if the WTRU can indicate to eNB a Relay WTRU status (e.g., that it is a Relay WTRU) and/or may (e.g., wants to) start ProSe WTRU-to-Network Relay discovery. For example, in RRC_CONNECTED, the WTRU may use the threshold(s) to determine if it can indicate to eNB the Relay WTRU status (e.g., that it is a Relay WTRU) and/or may (e.g., wants to) start ProSe WTRU-to-Network Relay discovery. The WTRU may initiate a request for ProSe WTRU-to-Network Relay discovery resources by dedicated signaling, for example respecting (e.g., these broadcasted) threshold(s). For example, if the eNB does not broadcast transmission resource pools for ProSe WTRU-to-Network Relay discovery, then the WTRU may initiate a request for ProSe WTRU-to-Network Relay discovery resources by dedicated signaling, respecting these broadcasted threshold(s).

A ProSe WTRU-to-Network Relay may perform sidelink communication (e.g., for ProSe WTRU-to-Network Relay operation). For example, a ProSe WTRU-to-Network Relay may perform sidelink communication for ProSe WTRU-to-Network Relay operation in RRC_CONNECTED. The ProSe WTRU-to-Network Relay may indicate to the eNB that it is a ProSe WTRU-to-Network Relay and/or that it may (e.g., intend to) perform ProSe WTRU-to-Network Relay sidelink communication. For example, after receiving a layer-2 link establishment request and/or TMGI monitoring request (e.g., upper layer message) from the Remote WTRU, the ProSe WTRU-to-Network Relay may indicate to the eNB that it is a ProSe WTRU-to-Network Relay and/or that it may (e.g., intends to) perform ProSe WTRU-to-Network Relay sidelink communication. The eNB may provide resources for ProSe WTRU-to-Network Relay communication.

The Remote WTRU may decide when to start monitoring for ProSe WTRU-to-Network Relay discovery. The Remote WTRU may transmit ProSe WTRU-to-Network Relay discovery solicitation messages. For example, the Remote WTRU may transmit ProSe WTRU-to-Network Relay discovery solicitation messages while in RRC_IDLE and/or in RRC_CONNECTED (e.g., depending on the configuration of resources for ProSe WTRU-to-Network Relay discovery). The eNB may broadcast a threshold. The threshold may be used by the Remote WTRU. For example, the threshold may be used by the Remote WTRU to determine if the WTRU may transmit ProSe WTRU-to-Network Relay discovery solicitation messages and/or to connect or communicate with ProSe WTRU-to-Network Relay WTRU. For example, a Remote WTRU may use the broadcasted threshold to determine if the WTRU (e.g., the Remote WTRU) may indicate to eNB that it is a Remote WTRU and/or may (e.g., wants to) participate in ProSe WTRU-to-Network Relay discovery and/or communication. Additionally, or alternatively, the Remote WTRU may be an RRC_CONNECTED Remote WTRU. The eNB may provide transmission resources using broadcast and/or dedicated signaling and/or reception resources. For example, the eNB may provide transmission resources using broadcast signaling for ProSe WTRU-to-Network Relay operation. The Remote WTRU may stop using ProSe WTRU-to-Network Relay discovery and/or communication resources. For example, the Remote WTRU may stop using ProSe WTRU-to-Network Relay discovery and/or communication resources when RSRP goes above the broadcasted threshold.

The (e.g., exact) time of traffic switching from Uu to PC5 and/or PC5 to Uu may be up to a layer (e.g., a higher layer).

The Remote WTRU may perform radio measurement(s) at a PC5 interface. The Remote WTRU may use the radio measurement(s) for ProSe WTRU-to-Network Relay selection and/or reselection (e.g., along with higher layer criterion). A ProSe WTRU-to-Network Relay may be selected (e.g., considered suitable in terms of radio criteria). For example, a A ProSe WTRU-to-Network Relay may be selected (e.g., considered suitable in terms of radio criteria) if the PC5 link quality exceeds a configured threshold (e.g., pre-configured or provided by eNB). The Remote WTRU may select the ProSe WTRU-to-Network Relay which satisfies higher layer criterion and/or has the best PC5 link quality among one or more (e.g., all) suitable ProSe WTRU-to-Network Relays.

The Remote WTRU may trigger ProSe WTRU-to-Network relay reselection. For example, the Remote WTRU may trigger ProSe WTRU-to-Network relay reselection when one or more of the following occurs: the PC5 signal strength of a current ProSe WTRU-to-Network relay is below a configured signal strength threshold; and/or the Remote WTRU receives a layer-2 (L2) link release message (e.g., an upper layer message) from the ProSe WTRU-to-Network relay.

WTRU-to-network relays for wearables may be used. For example, WTRU-to-Network relays for commercial use cases (e.g., tailored to wearables and/or IoT devices) may be used. WTRU-to-Network relays for wearables may be L2 relays (e.g., as opposed to ProSe WTRU-to-Network relays, which may use an L3 (e.g., IP layer) relaying approach). WTRU-to-Network relays for wearables may use one or more of the protocol stacks, for example as illustrated in FIGS. 2 and/or 3. FIG. 2 illustrates an example user plane radio protocol stack for an L2 evolved WTRU-to-Network relay (PC5). FIG. 3 illustrates an example control plane radio protocol stack for an L2 evolved WTRU-to-Network relay (PC5).

A single hop W2N relay may be used. For a discovery model, one or more (e.g., two) models may be used for discovery and/or relay (re) selection. For example, in a first model, the W2N relay may send announcement messages. In a second model, a Remote WTRU may send solicitation messages to ask for a relay service from another Relay WTRU. The W2N relay may respond to the solicitation message from the Remote WTRU(s).

A W2N relay may be used to extend network coverage. The WTRU may be configured with a Uu RSRP range [min_Uu_RSRP, max_Uu_RSRP], for example to transmit transmission discovery messages (e.g., for discovery transmission). The WTRU may be allowed to transmit a discovery message if max_Uu_RSRP≥ Uu and/or RSRP≥ min_Uu_RSRP.

A multi-path relay may be used. For example, for a multi-path scenario, a WTRU (e.g., Remote WTRU) may be able to (e.g., simultaneously) connect with the same gNB using a direct path (e.g., via Uu) and/or an indirect path (e.g., via a W2N relay). The multi-path scenario may be targeted to improve the reliability and/or throughput of the system.

For multi-path scenarios, a WTRU (e.g., Relay WTRU) that does not satisfy max_Uu_RSRP (e.g., the WTRU is close to cell center) may not be a good candidate for a Remote WTRU in single-path, but may (e.g., still) be a good W2N relay for a Remote WTRU in multi-path. Furthermore, relays may be capable of supporting multi-path (e.g., as a secondary leg but not primary) and/or single-path (e.g., Rel17 relay). Therefore, conditions for discovery and/or relay selection may be considered. For a Remote WTRU, conditions for discovery transmission (e.g., Uu RSRP<threshold) may not be applicable for multi-path in some examples. New conditions that relate to the need of setting up multi-path (e.g., reliability and throughput) and/or ensuring the QoS of the network service may be useful (e.g., needed). Therefore, discovery and relay new discovery and/or relay selection procedures may be designed to support multi-path scenarios.

As described herein, a WTRU may be (pre-) configured with a parameter. The (pre-) configuration of the parameter may be within a range (e.g., [a, b]) to perform a certain behavior. One omitted bound (either a or b) from the (pre-) configuration may be equivalent to the case that the bound is (pre-) configured with the maximum or minimum achievable value of the parameter.

As herein, a WTRU being (pre-) configured with may be used interchangeably with a WTRU being preconfigured with a parameter and/or the WTRU being configured with a parameter (e.g., from gNB via dedicated RRC or SIB).

As herein, the terms relay selection and relay reselection may be used interchangeably.

One or more of the solutions described herein may be described with relation to a discovery-relay-service message. Alternatively, or additionally, the solutions described herein may be used for and/or may be applicable to any discovery message or any other type of message (e.g., direct communication request (DCR) message).

Discovery transmission(s) may be performed as described herein. For example, a WTRU may support one or more relay services.

A WTRU (e.g., a Relay WTRU) may support one or more of the following relay services: single-path relay service; multi-path relay service, single-hop relay service; multi-hop relay service; Layer 2 (L2) relay service; and/or Layer 3 (L3) relay service.

A WTRU may support single-path relay service. For example, for a single-path relay service, the WTRU (e.g., Relay WTRU) may support relaying the Uu traffic of a Remote WTRU in the uplink and/or downlink direction. The WTRU may also support monitoring paging for the Remote WTRU. The WTRU may support receiving system information (SI) request(s) from a Remote WTRU, and/or forwarding the request(s) to the network. The WTRU may support forwarding the SI information (e.g., the SI request) to the Remote WTRU.

A WTRU may support multi-path relay service. For example, for multi-path relay service, the WTRU (e.g., Relay WTRU) may support relaying the Uu traffic of a Remote WTRU in the uplink and/or downlink direction. The WTRU may not support monitoring paging for the Remote WTRU. In some examples, the WTRU may not support receiving the SI request from the Remote WTRU. The WTRU may not support forwarding SI for the Remote WTRU in some examples.

A WTRU may support single-hop relay service. Alternatively, or additionally, a WTRU may support relaying data directly from the source to the destination. For example, a Relay WTRU supporting single-hop relay service may support relaying data directly from the source to the destination. In some examples, the WTRU may not support relaying data to an intermediate node and/or from an intermediate node. The source may be a gNB and/or another WTRU. Additionally, or alternatively, the destination may be a gNB and/or another WTRU.

A WTRU may support multi-hop relay service. For example, a Relay WTRU supporting multi-hop relay service may support relaying data from/to an intermediate node. The WTRU may additionally, or alternatively, support relaying data directly from the source to the destination. The source may be a gNB and/or another WTRU. Additionally, or alternatively, the destination may be a gNB and/or another WTRU.

A WTRU may support a L2 relay service. For example, a Relay WTRU supporting L2 relay service may support receiving configuration for relay data from the network. The Relay WTRU may support one or more of monitoring paging, receiving SI requests, and/or forwarding SI information to the Remote WTRU.

In an example, a Relay WTRU may support single-path relay service (e.g., only), multi-path relay service (e.g., only), or both single-path and multi-path relay service. A WTRU may support single-hop relay service (e.g., only), or multi-hop relay service. The WTRU supporting multi-hop relay service may additionally, or alternatively, support single-hop relay service. The WTRU may support being a W2 W relay (e.g., only), W2N relay (e.g., only), or both W2 W and W2N relay for a Remote WTRU.

A WTRU may request one or more relay services. For example, the WTRU (e.g., a Remote WTRU) may determine to request one or more of the following relay services: single-path relay service; multi-path relay service; single-hop relay service; multi-hop relay service; Layer 2 (L2) relay service; and/or Layer 3 (L3) relay service.

A WTRU may request single-path relay service. For example, a Remote WTRU requesting a single-path relay service may request a relay to forward Uu data from and/or to a gNB to and/or from the Remote WTRU. The WTRU may request a relay service. The relay service request may include performing monitoring paging, receiving SI requests, and/or forwarding SI information for the Remote WTRU.

A WTRU may request multi-path relay service. For example, a Remote WTRU requesting a multi-path relay service may request a Relay WTRU to forward Uu data from/to gNB to/from the Remote WTRU. In some examples, the WTRU may not request one or more of the Relay WTRU to monitor paging, receiving SI requests, and/or forwarding SI information for the Remote WTRU.

A WTRU may request single-hop relay service. For example, the Remote WTRU may request (e.g., in the discovery-relay-service message) to connect to a WTRU-to-Network (W2N) relay. The W2N relay may directly connect to the gNB for example. A Remote WTRU may request single-hop relay service. For example, the Remote WTRU may request (e.g., in the discovery-relay-service message) to connect to a WTRU-to-Network (U2N) relay. The WTRU-to-Network may connect directly to the gNB. In some examples, a Remote WTRU may request a single-hop relay service to connect to a WTRU to WTRU (U2U) relay. The U2U relay may connect to another WTRU.

A WTRU may request multi-hop relay service, which may allow the WTRU to connect to a WTRU-to-WTRU (W2 W) relay for example. The W2 W relay may connect to the network via W2N relay. The WTRU may implicitly and/or explicitly indicate that it is requesting to connect to the W2 W relay. For example, the WTRU may implicitly and/or explicitly indicate in a discovery-relay-service message that it is requesting to connect to the W2 W relay. A Remote WTRU may request multi-hop relay service, which may allow the WTRU (e.g., another WTRU) to connect to a U2U relay for example. The U2U relay may connect to the network via a WTRU-to-Network (U2N) relay. Alternatively, or additionally, the WTRU may transmit a discovery-service message which may implicitly and/or explicitly indicate that the WTRU is requesting to connect to the U2U relay. A Remote WTRU may request a relay service without requesting single-hop relay service or multi-hop relay service. The WTRU may connect to one or more of the single-hop relay service and the multi-hop relay service (e.g., after requesting a relay service).

A WTRU may request a relay service regardless of single-hop or multiple-hop. The WTRU may connect to a single-hop relay and/or multiple-hop relay service. A Remote WTRU may request a L2 relay service, for example, in the discovery-relay-service message. The Remote WTRU may receive (e.g., expect to receive) an SLRB configuration for L2 relay service from a gNB and/or a Relay WTRU.

A WTRU may request a L2 relay service in the discovery-relay-service message. The WTRU may expect to receive an SLRB configuration for L2 relay service from the gNB and/or Relay WTRU.

A WTRU may request an L3 relay service in the discovery-relay-service message. In some examples, the WTRU may not expect to receive SLRB configuration for relay service from the gNB and/or Relay WTRU.

The WTRU may perform discovery-relay-service message transmission. For example, a WTRU (e.g., Relay WTRU) may transmit a discovery-relay-service message (e.g., discovery-relay-service announcement). The discovery-relay-service message may be used to offer one or more of the following relay services to the Remote WTRU: single-path relay service, multi-path relay service, single-hop relay service, multiple-hop relay service, layer 2 relay service, and/or layer 3 relay service. In another example, a WTRU (e.g., Remote WTRU) may transmit a discovery-relay-service message (e.g., discovery-relay-service solicitation message). The discovery-relay-service message may be used to request a relay service from one or more Relay WTRUs. The WTRU may additionally, or alternatively, request one or more of the following relay services from one or more Relay WTRUs: single-path relay service, multi-path relay service, single-hop relay service, multiple-hop relay service, layer 2 relay service, and/or layer 3 relay service. As described herein, a discovery-relay-service message may be used for one or more of discovery-relay-service announcement, discovery-relay-service solicitation, and/or discovery-relay-service response message.

Network-scheduled discovery transmission may be performed. A WTRU may receive a (pre-) configuration for discovery-relay-service transmission. The WTRU may be (pre-) configured with one or more parameters and/or conditions for discovery-relay-service transmission. For example, the WTRU may receive configuration from the network via SIB and/or dedicated RRC message. Additionally, or alternatively, the WTRU may be preconfigured with one or more of the following parameters and/or conditions for discovery-relay-service transmission for one or more type of discovery-relay-service message: the Uu RSRP; a resource pool and/or resource pool type to transmit a type of discovery-relay-service message; parameters for discovery-relay-service transmissions; and/or the minimum Uu RSRP of a relay and/or minimum SL-RSRP/SD-RSRP for an SLRB/LCH.

The parameters and/or conditions for discovery-relay-service transmission may include the Uu RSRP. The parameters and/or conditions for discovery-relay-service transmission may include a Uu RSRP range for one or more (e.g., each) type of discovery-relay-service message, as described herein. For example, a WTRU (e.g., Relay WTRU) may be (pre-) configured with a minimum Uu RSRP to transmit a multi-path discovery-relay-service message. For example, the WTRU may transmit a multi-path discovery-relay-service message if the measured Uu RSRP is larger than the configured minimum Uu RSRP threshold (e.g., min_Uu_RSRP). In some scenarios, if the measured Uu RSRP is smaller than min_Uu_RSRP, the WTRU may not transmit the multi-path discovery-relay-service message. In another example, a WTRU (e.g., Remote WTRU) may be (pre-) configured with a range of Uu RSRP (e.g., min_Uu_RSRP and max_Uu_RSRP). The range of Uu RSRP may be used to transmit a multi-path discovery-relay-service message. For example, the WTRU may transmit a multi-path discovery-relay-service message if the measured Uu RSRP is within the configured range of Uu RSRP. In some scenarios, if the measured Uu RSRP is out of the configured range, the WTRU may not transmit multi-path discovery-relay-service messages.

The parameters and/or conditions for discovery-relay-service transmission may include a resource pool and/or resource pool type to transmit a type of discovery-relay-service message. For example, the WTRU may be (pre-) configured with a dedicated resource pool to transmit a multi-path discovery-relay-service message. For example, the WTRU may be (pre-) configured with a set of shared resource pools to transmit a multi-path discovery-relay-service message.

The parameters and/or conditions for discovery-relay-service transmission may include parameters for discovery-relay-service transmissions. For example, the parameters may include one or more of a range transmission power, MCS, number of subchannels, number of retransmissions, and/or the transmission periodicity of each discovery-relay-service message (e.g., a multi-path discovery-relay-service message).

The parameters and/or conditions for discovery-relay-service transmission may include the minimum Uu RSRP of a relay and/or minimum SL-RSRP/SD-RSRP for an SLRB/LCH. For example, a WTRU (e.g., Remote WTRU or Relay WTRU) may be (pre-) configured with, for one or more SLRBs/LCHs for multi-path relay service, a minimum Uu RSRP of a Relay WTRU and/or a minimum SL-RSRP/SD-RSRP to establish a multi-path relay service. For example, for an SLRB/LCH associated with multi-path relay service, the WTRU may establish a multi-path connection with a relay if the Uu RSRP of the relay is greater than or equal to a threshold and/or the SL-RSRP/SD-RSRP is greater than another threshold.

A WTRU may indicate to the network its supported relay service(s) capability. For example, the WTRU may indicate to the network whether it supports one or more of the following relay service: single-path, multi-path, single-hop, multiple-hop, layer 2, and/or layer 3 relay service.

The WTRU may receive an indication from the network indicating which type of relay the WTRU should act as. The WTRU may (e.g., then) perform transmission/reception of the discovery-relay-service message associated with the type of relay indicated by the network.

A WTRU may request a resource for discovery resource. A WTRU may trigger discovery-relay-service transmission for a type of discovery-relay-service message. The WTRU may (e.g., then) request a sidelink resource from the network for a (e.g., such) transmission. The WTRU may indicate which type of discovery-relay-service message (e.g., it wants) to transmit. For example, the WTRU may be (pre-) configured with an LCG, and/or destination ID/destination index for each type of discovery-relay-service message. The WTRU may (e.g., then) request the availability of discovery-relay-service data using the LCG, and/or destination ID/index (e.g., via SL BSR). The WTRU may (e.g., then) expect to receive a sidelink resource to transmit the type of discovery-relay-service message.

A WTRU (e.g., Relay WTRU) may report a set of Remote WTRUs (e.g., detected Remote WTRUs). The set of Remote WTRUs may include one or more Remote WTRU (e.g., one or more detected Remote WTRU). The WTRU (e.g., Relay WTRU) may monitor a discovery message (e.g., solicitation message) from one or more Remote WTRUs. The WTRU may report the set of detected Remote WTRUs, for example after monitoring the discovery message. The WTRU may be (pre-) configured with a SD-RSRP threshold. The SD-RSRP threshold may be associated with the set of Remote WTRUs (e.g., the report of the set of Remote WTRUs). For example, the WTRU may report the set of detected Remote WTRUs if SD-RSRP transmitted from a Remote WTRU is greater than a (pre-) configured threshold. The WTRU may be indicated in a (e.g., each) solicitation message (e.g., associated with one or more type of requesting relay service). For example, the WTRU may indicate whether the Remote WTRU is requesting single-path-relay service, multi-path relay service, single-hop relay service, and/or multi-hop relay service. The WTRU may (e.g., then) transmit (e.g., indicate) to the network, for a (e.g., each) reported Remote WTRU, which type of relay service the Remote WTRU is requesting. In some examples, the WTRU may report to the network the set of Remote WTRUs requesting one type of relay service. For example, the WTRU may report the set of Remote WTRUs requesting multipath relay service. For example, the WTRU may report the set of Remote WTRUs requesting single-path relay service.

The Relay WTRU may determine which set of detected Remote WTRUs to report to the network. The WTRU (e.g., relay UE) may determine which set of detected Remote WTRUs to report to the network based on one or more of the following. The WTRU may determine which set of detected Remote WTRUs to report to the network based on a (pre-) configured relay type. For example, the WTRU may report the set of detected Remote WTRUs based on its (pre-) configured relay type. For example, if the WTRU is (pre-) configured with multi-path relay type, the WTRU may report the set of Remote WTRUs requesting multipath service. For example, if the WTRU is (pre-) configured with single-path relay service, the WTRU may report the set of Remote WTRUs requesting single-path relay service only.

The WTRU may determine which set of detected Remote WTRUs to report to the network based on a Uu RSRP of the relay. For example, the WTRU may report the set of Remote WTRUs requesting multi-path relay if Uu RSRP satisfies the (pre-) configured Uu RSRP threshold(s) for being multi-path relay (e.g., the Uu RSRP is larger than a Uu RSRP threshold). Alternatively, or additionally, the WTRU may report the set of Remote WTRUs requesting single-path relay service if Uu RSRP satisfies the (pre-) configured Uu RSRP threshold(s) for being single path relay (e.g., Uu RSRP is larger than one Uu RSRP threshold and smaller than another Uu RSRP threshold). In another example, the WTRU may report all the detected Remote WTRUs requesting relay service (e.g., both single-path and multi-path) if Uu RSRP satisfies the (pre-) configured Uu RSRP thresholds for both single-path and multi-path relay services.

The WTRU may report a set of Relay WTRUs (e.g., detected Relay WTRUs). The set of Relay WTRUs may include one or more Relay WTRU (e.g., one or more detected Relay WTRU). The WTRU (e.g., Remote WTRU) may monitor one or more discovery message from one or more Relay WTRUs. The WTRU may (e.g., then) report the set of detected Relay WTRUs. The WTRU may be (pre-) configured with a SD-RSRP threshold. The SD-RSRP threshold may be associated with the set of Relay WTRUs (e.g., a report of the set of Relay WTRUs). The WTRU may report the detected Relay WTRUs. For example, the WTRU may report the detected Relay WTRUs if SD-RSRP transmitted from the Relay WTRU is greater than a (pre-) configured threshold. The WTRU may transmit (e.g., indicate) in a (e.g., each) discovery message the type of relay service(s) (e.g., offering relay service(s)). For example, the WTRU may transmit (e.g., indicate) whether the Relay WTRU is offering single-path-relay service, multi-path relay service, single-hop relay service, and/or multi-hop relay service. The WTRU may (e.g., then) indicate to the network, for a (e.g., each) reported Relay WTRU, which type or types of relay service the Relay WTRU is offering. In some examples, the WTRU may report to the network the set of Relay WTRUs offering one or more (e.g., one) type of relay service. For example, the WTRU may report the set of Relay WTRUs offering multipath relay service. For example, the WTRU may report the set of Relay WTRUs offering single-path relay service.

A WTRU may determine which set of Relay WTRUs (e.g., detected Relay WTRUs) to report to the network. The set of Relay WTRUs may include one or more Relay WTRUs (e.g., one or more detected Relay WTRU). A WTRU (e.g., Remote WTRU) may monitor one or more discovery-relay-service messages from one or more (e.g., multiple) Relay WTRUs. The WTRU may (e.g., then) determine which set of detected Relay WTRUs to report to the network based on one or more of the conditions herein (e.g., the following). The WTRU may determine which set of detected Relay WTRUs to report to the network based on the (pre-) configured type of relay. For example, the WTRU may be (pre-) configured to report one type of detected relay (e.g., relays supporting multipath service). The WTRU may (e.g., then) report the set of relays supporting the (pre-) configured type (e.g., relays supporting multipath service).

The WTRU may determine which set of detected Relay WTRUs to report to the network based on the Uu RSRP of the Remote WTRU. For example, the WTRU may report the set of Relay WTRUs supporting multipath services if its Uu RSRP is larger than a threshold. In another example, if the Uu RSRP is smaller than a threshold, the WTRU may report all detected relays and/or the relays supporting single-path relay service.

The WTRU may determine which set of detected Relay WTRUs to report to the network based on a connection status of the WTRU (e.g., whether the WTRU is connected directly with the gNB via Uu or via a U2N relay). In one example, when the WTRU is connected with the gNB via Uu, the WTRU may report the set of detected relays supporting multipath relays. In another example, when the WTRU is connected with gNB via another relay, the WTRU may report all detected relays, or the set of detected relays supporting single-path relay services.

The WTRU may determine which set of detected Relay WTRUs to report to the network based on the Uu RSRP of the Relay WTRU. The Uu RSRP may be indicated in the discovery-relay-service message of the Relay WTRU. For example, the WTRU may be (pre-) configured to monitor one or more discovery-relay-service message from relay to ask for multipath service. In some examples, the WTRU may report the set of relay having Uu RSRP being greater than a (pre-) configured threshold. For example, the WTRU may be (pre-) configured to monitor one or more discovery-relay-service message from one or more Relay WTRU. The WTRU may be (pre-) configured to monitor one or more discovery-relay-service message from one or more Relay WTRU to ask for single-path relay service. The WTRU may report the set of Relay WTRUs having a Uu RSRP greater than or equal to a threshold and/or smaller than a threshold (e.g., a different threshold).

The WTRU may determine which set of detected Relay WTRUs to report to the network based on a QoS, for example of the established SLRB/LCH. For example, the WTRU may report the Relay WTRUs wih a Uu RSRP higher than a threshold. The threshold may be a function of QoS of the established SLRB/LCH. For example, for a first established SLRB/LCH, the WTRU may report the Relay WTRUs having a Uu RSRP greater than a first threshold. Additionally, or alternatively, for the second established SLRB/LCH, the WTRU may report the Relay WTRUs having a Uu RSRP being greater than a second threshold.

A Relay WTRU may indicate information in a discovery message. For example, the Relay WTRU may indicate the Uu information in the network. The Relay WTRU may indicate the Uu information in the network to support the Remote WTRU in relay selection. The WTRU may indicate one or more of (e.g., the following) Uu information as herein. The WTRU may indicate a distance to the gNB. Additionally, or alternatively, the WTRU may indicate a location of the WTRU. For example, the WTRU may indicate whether the WTRU is at the cell edge or cell center. In some examples, the WTRU may assume that when the relay is at the cell edge, it can support (e.g., either) single path and/or multipath relay service. Alternatively, or additionally, when the Relay WTRU is at a cell center, it may support multipath relay service (e.g., only).

A Remote WTRU may indicate a connection status in a discovery-service message. For example, the WTRU may indicate one or more of the following parameters in the discovery-service-message when the WTRU transmits the discovery solicitation message. The Remote WTRU may indicate a Uu connection status (e.g., whether it is connected to gNB and/or whether it is connected to gNB via Uu and/or via another U2N relay). Alternatively, or additionally, the Remote WTRU may indicate the Uu RSRP. Alternatively, or additionally, the Remote WTRU may indicate a distance to the gNB.

A WTRU may request one or more resource for a discovery-relay-service transmission. For example, the WTRU may request sidelink resources for discovery transmission (e.g., solicitation message or announcement message). The WTRU may alternatively, or additionally, indicate to the network the relay service the WTRU is offering/requesting. This approach may help the network scheduling the resource to the WTRU properly.

The WTRU may receive an indication to transmit a discovery-relay-service message. For example, the network may transmit to the WTRU which type of relay service it needs to request/offer. For example, the network may indicate that to the WTRU whether to request/offer single-path, multi-path, single-hop, and/or multi-hop relay service. The WTRU may perform transmission of discovery messages including the type of relay service it is offering/requesting as indicated by the network. Alternatively, or additionally, the WTRU may transmit to the network which type of relay service it needs to request/offer. For example, the WTRU may indicate that to the network whether to request/offer single-path, multi-path, single-hop, and/or multi-hop relay service.

The WTRU may report a set of detected Remote WTRUs. In an example, a WTRU (e.g., Relay WTRU) may monitor for a discovery message (e.g., solicitation message) from Remote WTRUs. The WTRU may (e.g., then) report the set of detected Remote WTRUs. The WTRU may be (pre-) configured with a SD-RSRP threshold. Additionally, or alternatively, the WTRU may report the detected Remote WTRUs. For example, the WTRU may report the detected Remote WTRUs if SD-RSRP transmitted from the Remote WTRU is greater than a (pre-) configured threshold. The WTRU may be indicated in each solicitation message the type of requesting relay service. For example, the WTRU may be indicated based on whether the Remote WTRU is requesting one or more of single-path-relay service, multi-path relay service, single-hop relay service, and/or multi-hop relay service. The WTRU may (e.g., then) indicate to the network, for each reported Remote WTRU, which type of relay service the Remote WTRU is requesting. The WTRU may report to the network the set of Remote WTRUs requesting one type of relay service. For example, the WTRU may report the set of Remote WTRUs requesting multipath relay service. For example, the WTRU may report the set of Remote WTRUs requesting single-path relay service.

The Relay WTRU may determine which set of Remote WTRUs (e.g., detected Remote WTRUs) to report to the network. The set of Remote WTRUs may include one or more Remote WTRU (e.g., one or more detected Remote WTRU). A WTRU (e.g., Relay WTRU) may determine which set of detected Remote WTRUs to report to the network based on one or more of the condition herein (e.g., the following). The WTRU (e.g., Relay WTRU) may determine which set of detected Remote WTRUs to report to the network based on a (pre-) configured relay type. For example, the WTRU may report the set of detected Remote WTRUs based on its (pre-) configured relay type. For example, if the WTRU is (pre-) configured with multi-path relay type, the WTRU may report the set of Remote WTRUs requesting for multipath service. For example, if the WTRU is (pre-) configured with single-path relay service, the WTRU may report the set of Remote WTRUs requesting for single-path relay service only.

A WTRU (e.g., Relay WTRU) may determine which set of detected Remote WTRUs to report to the network based on the Uu RSRP of the relay. For example, the WTRU may report the set of Remote WTRUs requesting for multi-path relay if Uu RSRP satisfies the (pre-) configured Uu RSRP threshold(s) for being a multi-path relay (e.g., the Uu RSRP is larger than a Uu RSRP threshold). Alternatively, or additionally, the WTRU may report the set of Remote WTRUs requesting a single-path relay service if the Uu RSRP satisfies the (pre-) configured Uu RSRP threshold(s) for being a single path relay (e.g., Uu RSRP is larger than one Uu RSRP threshold and smaller than another Uu RSRP threshold). In another example, the WTRU may report all the detected Remote WTRUs requesting for relay service (e.g., both single-path and multi-path) if Uu RSRP satisfies the (pre-) configured Uu RSRP thresholds for both single-path and multi-path relay services.

The WTRU may report a set of detected relays. For example, a WTRU (e.g., Remote WTRU) may monitor for a discovery message. The WTRU may monitor for a discovery message from one or more Relay WTRUs. The WTRU may (e.g., then) report the set of detected Relay WTRUs. The WTRU may be (pre-) configured with a SD-RSRP threshold. The WTRU may use the SD-RSRP threshold to report the detected Relay WTRUs. For example, the WTRU may report the detected Relay WTRUs if SD-RSRP transmitted from the Relay WTRU is greater than a (pre-) configured threshold. The WTRU may be indicated in one or more (e.g., each) discovery message. For example, the type of offering relay service(s) may be indicated in one or more (e.g., each) discovery message. In some examples, the WTRU may indicate whether the Relay WTRU is offering single-path-relay service, multi-path relay service, single-hop relay service, and/or multi-hop relay service. The WTRU may then indicate (e.g., transmit/report) to the network (e.g., for each reported Relay WTRU) which type of relay service the Relay WTRU is offering. The WTRU may report (e.g, transmit a reporting message) to the network the set of Relay WTRUs offering one or more (e.g., one) type of relay service. For example, the WTRU may report the set of Relay WTRUs offering multipath relay service. For example, the WTRU may report the set of Relay WTRUs offering single-path relay service.

A WTRU may determine which set of Relay WTRUs (e.g., detected Relay WTRUs) to report to the network. The set of Relay WTRUs may include one or more Relay WTRU (e.g., one or more detected Relay WTRU). A WTRU (e.g., Remote WTRU) may monitor discovery-relay-service messages from one or more (e.g., multiple relays). The WTRU may (e.g., then) determine which set of detected Relay WTRUs to report to the network based on one or more of the following. The WTRU may determine which set of detected Relay WTRUs to report to the network based on a (pre-) configured type of relay. For example, the WTRU may be (pre-) configured to report one or more (e.g., one) type of detected relay (e.g., relays supporting multipath service). The WTRU may (e.g., then) report the set of relays supporting the (pre-) configured type (e.g., relays supporting multipath service).

The WTRU may determine which set of detected Relay WTRUs to report to the network based on a Uu RSRP of the Remote WTRU. For example, the WTRU may report the set of Relay WTRUs supporting multipath services if its (e.g, the Relay WTRU's) Uu RSRP is larger than a threshold. In another example, if its Uu RSRP is smaller than a threshold, the WTRU may report all detected relays or the relays supporting single-path relay service.

The WTRU may determine which set of detected Relay WTRUs to report to the network based on a connection status of the WTRU (e.g., whether the WTRU is connected directly with the gNB via Uu or via a U2N relay). In one example, when the WTRU is connected with the gNB via Uu, the WTRU may report the set of detected relays supporting multipath relays. In another example, when the WTRU is connected with gNB via another relay, the WTRU may report all detected relays, or the set of detected relays supporting single-path relay services.

The WTRU may determine which set of detected Relay WTRUs to report to the network based on the Uu RSRP of the Relay WTRU. The Uu RSRP of the Relay WTRU may be indicated in the discovery-relay-service message of the Relay WTRU. For example, the WTRU may be (pre-) configured to monitor discovery-relay-service message from relay to ask for multipath service. The WTRU may report the set of relay having Uu RSRP being greater than a (pre-) configured threshold. For example, the WTRU may be (pre-) configured to monitor discovery-relay-service message from relay to ask for single-path relay service. The WTRU may report the set of Relay WTRUs having Uu RSRP greater than a (e.g., a first) threshold and/or smaller than another (e.g., a second) threshold.

The WTRU may determine which set of detected Relay WTRUs to report to the network based on a QoS of the established SLRB/LCH. For example, the WTRU may report the Relay WTRUs having a Uu RSRP exceeding than a threshold. The threshold may be a function of QoS of the established SLRB/LCH. For example, for a first established SLRB/LCH, the WTRU may report the relays having Uu RSRP exceeding than a first threshold. Additionally, or alternatively, for the second established SLRB/LCH, the WTRU may report the relays having Uu RSRP being greater than a second threshold (e.g., a different threshold).

The WTRU may request one or more resources for discovery-relay-service transmission. In an example, the WTRU may request one or more sidelink resources for discovery transmission (e.g., solicitation message and/or announcement message). The WTRU may also indicate (e.g., transmit) to the network the relay service the WTRU is offering/requesting. This WTRU may help the network in scheduling the one or more resources to the WTRU.

The WTRU may receive an indication to transmit a discovery-relay-service message. In an example, the WTRU may receive an indication from the network. The indication may indicate which type of relay service the WTRU should request and/or offer. For example, the indication may indicate to the WTRU whether to request/offer single-path, multi-path, single-hop, and/or multi-hop relay service. The WTRU may transmit one or more discovery messages. The one or more discovery messages may include the type of relay service the WTRU is offering and/or requesting (e.g., as indicated by the network).

A WTRU may transmit one or more autonomous discovery messages. For example, a WTRU may determine to perform transmission of (e.g., transmit) a discovery-relay-service message. The WTRU may trigger discovery-relay-service transmission and/or relay (re) selection. For example, the WTRU may trigger discovery-relay-service transmission and/or relay (re) selection based on one or any combination of the following events/conditions: Uu RSRP is with a (pre-) configured range; a relay load; an indication from another node (e.g., a gNB); reception of an SLRB/LCH configuration (e.g., including at least one SLRB/LCH requiring multi-path relay service); the arrival of data from a set of SLRBs/LCHs in the buffer; the amount of data from a set of SLRBs/LCHs being greater than or equal to a threshold; the reception of a discovery-relay message from another WTRU; the CBR of a resource pool associated with discovery-relay message transmission being smaller than a threshold; and/or the distance to the gNB being within a configured range.

The WTRU may trigger a discovery-relay-service transmission and/or relay (re) selection based on Uu RSRP being with a (pre-) configured range. For example, the WTRU may be (pre-) configured with a range of Uu-RSRP (e.g., min_Uu_RSRP, and/or max_Uu_RSRP) to transmit a discovery-relay-service message. In some examples, the WTRU may trigger the discovery-relay-service transmission if the measured Uu-RSRP is within the (pre-) configured range. In other examples, if the measured Uu-RSRP is out of the (pre-) configured range, the WTRU may not transmit the message.

The WTRU may trigger discovery-relay-service transmission and/or relay (re) selection based on a relay load. For example, a WTRU (e.g., Relay WTRU) may be (pre-) configured with a relay load range (e.g., to transmit a discovery-relay-service message). The WTRU may (e.g., then) transmit the discovery-relay-service message, for example if the load of the WTRU is within the (pre-) configured range.

The WTRU may trigger a discovery-relay-service transmission and/or relay (re) selection based on an indication from another node (e.g., a gNB). For example, another node (e.g., gNB) may indicate and/or request the WTRU to perform a discovery-relay-service transmission. The WTRU may (e.g., then) transmit a discovery-relay-service message (e.g., based on the request and/or indication from the node).

The WTRU may trigger a discovery-relay-service transmission and/or relay (re) selection, for example based on (e.g., reception of) an SLRB/LCH configuration. The SLRB/LCH configuration may include one or more SLRB/LCH requiring multi-path relay service. For example, the WTRU may receive a SLRB/LCH configuration from another node (e.g., gNB) which may include one or more SLRB/LCH requiring multi-path relay service (e.g., the SLRB/LCH having priority and/or reliability being greater than or equal to a threshold). The WTRU may (e.g., then) trigger a discovery-relay-service transmission. The WTRU may transmit a discovery-relay-service message, which for example may request multi-path relay service.

The WTRU may trigger a discovery-relay-service transmission and/or relay (re) selection based on the arrival of data from a set of SLRBs/LCHs in the buffer. For example, the WTRU (e.g., a Remote WTRU) may be (pre-) configured with one or more SLRBs/LCHs for multi-path relay service. The WTRU may (e.g., then) trigger transmission of a discovery-relay-service message. The discovery-relay-service-message may request a multi-path relay service.

The WTRU may trigger a discovery-relay-service transmission and/or relay (re) selection based on the amount of data from a set of SLRBs/LCHs being greater than or equal to a threshold. For example, the WTRU (e.g., a Remote WTRU) may be (pre-) configured one or more SLRBs/LCHs for multi-path relay service. The WTRU may be (pre-) configured the minimum amount of data from the set of SLRBs/LCHs for multi-path relay to trigger discovery-relay-service transmission. The WTRU may then trigger a discovery-relay-service message transmission, which may request a multi-path relay service, if the amount of data in a set of SLRBs/LCHs is greater than or equal to a threshold. The threshold may be (pre-) configured.

The WTRU may trigger a discovery-relay-service transmission and/or relay (re) selection based on the amount of data from a set of SLRBs/LCHs being greater than (e.g., exceeding) a threshold. For example, the WTRU (e.g., a Remote WTRU) may be (pre-) configured with one or more SLRBs/LCHs for multi-path relay service. The WTRU may be (pre-) configured with a minimum amount of data, for example from the set of SLRBs/LCHs for multi-path relay, to trigger discovery-relay-service transmission. The WTRU may (e.g., then) trigger a discovery-relay-service message transmission. The discovery-relay-service-message may include a request a multi-path relay service. For example, the discovery-relay-service-message may include a request a multi-path relay service if the amount of data in a set of SLRBs/LCHs is greater than or equal to a threshold. The threshold may be (pre-) configured.

The WTRU may trigger a discovery-relay-service transmission and/or relay (re) selection based on the reception of a discovery-relay message from another WTRU. For example, the WTRU may determine whether to transmit a discovery message based on the reception of discovery message offering a (e.g., the same) relay service. For example, the WTRU may monitor one or more discovery messages from one or more other Relay WTRUs. The WTRU may determine whether to transmit a discovery message based on whether the WTRU receives a (e.g., any) discovery message (e.g., offering the same type of relay service), for example having SD-RSRP being greater than or equal to a threshold. In some examples, if the WTRU detects a discovery message offering the same relay service and having SD-RSRP being greater than a (pre-) configured threshold, the WTRU may not transmit discovery message. In other examples, the WTRU may (e.g., otherwise) transmit the discovery message.

The WTRU may trigger a discovery-relay-service transmission and/or relay (re) selection based on the CBR of a resource pool being less than a threshold. For example, the CBR of a resource pool may be associated with a discovery-relay message. The WTRU may be (pre-) configured with a dedicated resource pool, for example for transmission of one or more types of discovery message for one or more types of relay-services. The WTRU may determine to transmit a discovery-relay-service message, for example if the CBR of the resource pool is less than a threshold. In other examples (e.g., otherwise), the WTRU may not transmit a discovery message.

The WTRU may trigger discovery-relay-service transmission and/or relay (re) selection based on the distance to the gNB. For example, the WTRU may trigger discovery-relay-service transmission and/or relay (re) selection based on the distance to the gNB being within a configured range. For example, the WTRU (e.g., Relay WTRU) may determine whether to transmit a certain discovery-relay-message based on the distance to the gNB. In some examples, the WTRU may be (pre-) configured with a range of distances to the gNB, for example to transmit a multi-path discovery-relay-service message. In some examples, the WTRU may trigger discovery transmission if the distance between the WTRU and the gNB is within the (pre-) configured range.

A WTRU may determine to transmit (e.g., transmit) one or more discovery-relay-service message (e.g., a discovery-relay-service message). For example, a WTRU (e.g., Relay WTRU) may be (pre-) configured with a Uu RSRP range (e.g., [Uu RSRP threshold1, Uu RSRP threshold2]) The Uu RSRP range may be associated with transmitting a discovery-relay-service message. In one example, if the WTRU supports single-path relay service, the WTRU may transmit discovery-relay-service messages if its Uu RSRP is within the range. In another example, if the WTRU supports multi-path relay service, the WTRU may ignore the upper bound of the (pre-) configured Uu RSRP threshold range and transmit a discovery-relay-service message. For example, the WTRU may transmit discovery-relay-service messages if Uu RSRP is greater than an Uu RSRP threshold (e.g., Uu RSRP>Uu RSRP threshold1).

The WTRU may determine whether a cell supports one or more relay service (e.g., one relay service). For example, the WTRU may determine whether a cell supports a certain relay service (e.g., multi-path relay service). The WTRU may receive a SIB. The SIB may implicitly/explicitly indicate whether a relay service is supported or not (e.g., the SIB may implicitly/explicitly indicate whether multi-path relay service is supported or not).

The WTRU may determine whether to transmit one or more discovery-relay-service messages (e.g., a discovery-relay-service message), for example based on one or more indications from a cell. For example, the WTRU may be (pre-) configured with a Uu RSRP range (e.g., [Uu RSRP threshold1, Uu RSRP threshold2]). The Uu RSRP range may be associated with transmitting discovery-relay-service messages. The WTRU may have a Uu RSRP exceeding the second Uu RSRP threshold (e.g., Uu RSRP threhold2). The WTRU may (e.g., then) determine whether to transmit a discovery message based on whether the cell supports multipath relay service. For example, if the cell supports multi-path relay service, the WTRU may transmit a discovery-relay-service message. In another example, if the cell does not support multi-path relay service, the WTRU may not transmit discovery-relay-service messages.

A WTRU may determine whether to respond to a Remote WTRU. A WTRU (e.g., Relay WTRU), for example upon detection/reception of a discovery-relay-service message, may perform one or more of the (e.g., following) actions as herein to respond to the Remote WTRU. The WTRU (e.g., Relay WTRU) may perform resource allocation and/or transmit a response message to the Remote WTRU. In another example, the WTRU (e.g., Relay WTRU) may request a sidelink resource to respond to the Remote WTRU. Additionally, or alternatively, the WTRU (e.g., Relay WTRU) may report the detected Remote WTRU to the network.

A Relay WTRU that supports multipath relay service may determine whether to respond to a Remote WTRU based on one or more the conditions as herein (e.g., the following). The Relay WTRU may determine whether to respond to a Remote WTRU based on a Uu RSRP of the WTRU. For example, the WTRU may be (pre-) configured with a Uu RSRP threshold to be a multipath relay. For example, the WTRU may respond to the Remote WTRU if Uu RSRP exceeds the threshold. In another example if the Uu RSRP does not exceed the threshold, the WTRU may not respond to the Remote WTRU.

The Relay WTRU may determine whether to respond to a Remote WTRU based on one or more type of requested relay service. For example, the WTRU may not respond to a Remote WTRU requesting single-path relay service. The WTRU may respond to a Remote WTRU requesting multi-path relay service. Additionally, or alternatively, the Relay WTRU may determine whether to respond to a Remote WTRU based whether the cell supports multipath relay service. For example, the WTRU may not respond to Remote WTRU requesting multipath service. For example, the WTRU may respond to a Remote WTRU requesting for single-path relay service if the Relay WTRU supports both multipath and single path relay service.

The WTRU may determine a (e.g., which) discovery-relay-service message to transmit. For example, the WTRU (e.g., Relay WTRU) may determine to transmit (e.g., transmit) a discovery-relay-service message. The WTRU may determine which type of discovery-relay-service message to transmit (e.g., transmit) based on one or more of the following: the measured Uu RSRP; the relay load; a relay capability; the requested relay service; the intended relay service to support; an indication from another node (e.g., gNB); a priority associated with each discovery-relay-service message; a predefined transmission order of each discovery service message; and/or the distance to the gNB.

The WTRU may determine which type of discovery-relay-service message to transmit based on the measured Uu RSRP. In some examples, the WTRU (e.g., Relay WTRU) may be (pre-) configured with a range of Uu RSRP (e.g., min_Uu_RSRP, and/or max_Uu_RSRP), for example to transmit a (e.g., each) type of discovery-relay-service message. For example, the WTRU may be preconfigured with and/or receive (e.g., via RRC and/or SIB) one or more (e.g., two) ranges of Uu RSRP thresholds. The first range (e.g., of Uu RSRP thresholds) may be associated with the single-path relay service and/or a second range (e.g., of Uu RSRP thresholds) may be associated with multi-path relay service. The WTRU may (e.g., then) determine a (e.g., which) discovery-relay-service message to transmit based on whether the Uu RSRP is within a (e.g., which) (pre-) configured range. For example, the WTRU may be (pre-) configured with two Uu RSRP ranges, in which one Uu RSRP range may be associated with single-path relay service and another Uu RSRP range may be associated with multi-path relay service. The WTRU may (e.g., then) determine to transmit (e.g., transmit) a single-path discovery-relay-service message, for example if the Uu RSRP is within the range (pre-) configured for single-path relay. The WTRU may determine to transmit a multi-path discovery-relay-service message, for example if the measured Uu RSRP is within the range (pre-) configured for multi-path relay service. If the WTRU satisfies two Uu RSRP ranges (e.g., the first range and the second range), the WTRU may transmit the prioritized discovery-relay-service message in some examples. The WTRU may be (pre-) configured with which type of discovery-service message is prioritized. For example, the WTRU may be (pre-) configured to prioritize single-path discovery-service messages. Alternatively, or additionally, the WTRU may be (pre-) configured to prioritize multi-path discovery-service messages. In some examples, the WTRU may transmit a discovery-service message which may implicitly and/or explicitly indicate that the WTRU supports both single-path and multi-path relay services.

For example, the WTRU (e.g., Remote WTRU) may be (pre-) configured with one or more (e.g., two) ranges of Uu RSRP thresholds, in which a first range may be associated with the solicitation for single path relay-service and/or a second range may be associated with the solicitation for multipath relay service. The WTRU may (e.g., then) determine which solicitation message to transmit based on whether the Uu RSRP is within the first and/or the second range of Uu RSRP. In some examples, the WTRU may transmit the solicitation for single path relay service if Uu RSRP is within the first range and/or it may transmit the solicitation message for multipath relay service if Uu RSRP is within the second range. If Uu RSRP satisfies both ranges, the WTRU may transmit the prioritized solicitation message in some examples. Alternatively, or additionally, if Uu RSRP satisfies both ranges, the WTRU may transmit the solicitation message, for example asking for (e.g., either) single path and/or multipath relay service.

The WTRU may determine which type of discovery-relay-service message to transmit based on the relay load. A WTRU (e.g., Relay WTRU) may be (pre-) configured with one or more (e.g., two) relay load ranges, for example to transmit a discovery-relay-service messages. A (e.g., one) relay load range may be used for single-path relay and/or one (e.g., another) relay load range may be used for multi-path relay service. If the relay load is with the first relay load range, the WTRU may transmit single-path discovery-relay-service message for example. In other examples (e.g., otherwise), if the relay load is within the second relay load range, the WTRU may transmit multi-path discovery-relay-service message.

The WTRU may determine which type of discovery-relay-service message to transmit based on a relay (e.g., Relay WTRU) capability. For example, a WTRU (e.g., Relay WTRU) may determine which discovery-relay-service message to transmit based on its relay capability. In some examples, the WTRU may satisfy conditions to transmit multiple types of discovery-relay-service message. The WTRU may (e.g., then) determine a (e.g., which) message to transmit based on its capability. For example, the WTRU may satisfy the conditions to transmit (e.g., either) a single-path and/or a multi-path discovery-relay-service message. The WTRU may (e.g., then) transmit a single-path discovery-relay-service message, for example if it supports the single-path relay service (e.g., only). In other examples (e.g., otherwise), if the WTRU supports multi-path relay service (e.g., only), the WTRU may transmit a multi-path discovery-relay-service message.

The WTRU may determine which type of discovery-relay-service message to transmit based on a requested relay service. In some examples, the WTRU may transmit a multi-path discovery-relay-service message, for example if the WTRU is requested (e.g., from another node or from the application layer of the WTRU) to perform multi-path discovery-relay-service message transmission.

The WTRU may determine which type of discovery-relay-service message to transmit based on the intended relay service to support. For example, the WTRU may determine which relay service to support. The WTRU may (e.g., then) determine which discovery-relay-service message to transmit, for example based on the relay service the WTRU determines (e.g., wants) to support. In some examples, the WTRU may determine to support (e.g., become) a single-path relay, and/or the WTRU may (e.g., then) transmit a single-path discovery-relay-service message. In other examples, the WTRU may determine to support (e.g., become) a multi-path relay, and/or the WTRU may (e.g., then) transmit a multi-path discovery-relay-service message.

The WTRU may determine which type of discovery-relay-service message to transmit, for example based on an indication and/or request from another node (e.g., gNB). In some examples, the WTRU may (e.g., first) indicate to the network its supported relay capability. The WTRU may (e.g., then) receive an indication from the network. The indication may indicate which relay service(s) to support. The WTRU may (e.g., then) determine which discovery-relay-service message to transmit based, for example on the indication from the network of which relay service to support.

The WTRU may determine which type of discovery-relay-service message to transmit based on the priority associated with a (e.g., each) discovery-relay-service message. For example, the WTRU may be (pre-) configured with a priority associated with a (e.g., each) discovery-relay-service message. In some examples, if the WTRU satisfies the conditions to transmit multiple discovery-relay-service messages, the WTRU may determine to transmit (e.g., transmit) the discovery message with higher priority. For example, the WTRU may be (pre-) configured for a single-path relay service message to have higher priority than the multi-path relay service message. The WTRU may (e.g., then) determine to transmit the single-path discovery-relay-service message if the conditions to transmit single-path and multi-path discovery-relay-service messages are satisfied. For example, the WTRU may be (pre-) configured such that multipath relay service messages have higher priority than the single-path relay service messages. The WTRU may (e.g., then) determine to transmit multipath discovery-relay-service message if the conditions to transmit multipath discovery-relay-service messages are satisfied.

The WTRU may determine which type of discovery-relay-service message to transmit based on the predefined transmission order of each discovery service message. The WTRU may be (pre-) configured with a transmission order of a (e.g., each) discovery-relay-service message, for example if other conditions to transmit multiple discovery-relay-service are satisfied. In some examples, the WTRU may transmit a single-path discovery-relay-service message if the WTRU satisfies conditions to transmit (e.g., both) a single-path and/or a multi-path discovery-relay-service message. For example, the WTRU may transmit a multi-hop discovery-relay-service message if the WTRU satisfies conditions to transmit (e.g., both) single-hop and/or multi-hop discovery-relay-service messages.

The WTRU may determine which type of discovery-relay-service message to transmit based on the distance to the gNB. For example, the WTRU may be (pre-) configured with one or more (e.g., multiple) ranges of the distance to the gNB. A (e.g., each) range may be associated with one type of relay-service-message (e.g., one range may be associated with single-path-relay-service message and another range may be associated with multi-path-relay-service message). The WTRU may (e.g., then) determine a (e.g., which) relay-service-message to transmit based on the distance to the gNB.

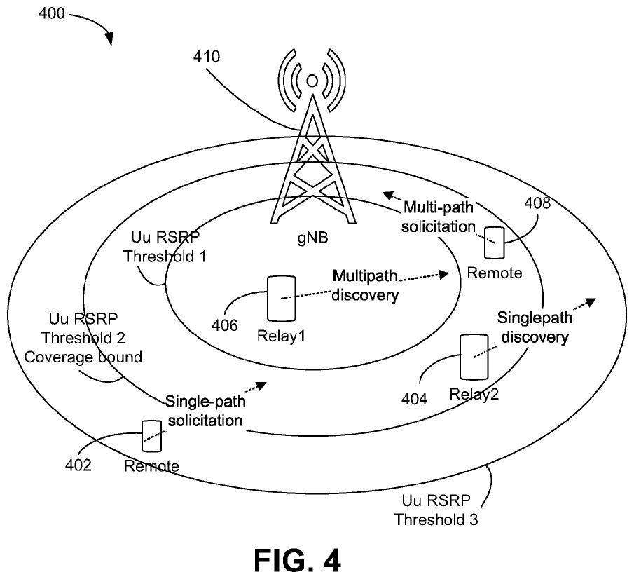

FIG. 4 illustrates an example system 400 illustrating a WTRU determining whether to transmit single-path discovery vs. (e.g., and/or) multipath discovery and single-path solicitation vs. multipath solicitation. As shown in FIG. 4, a Relay WTRU 406 may determine whether to transmit single-path vs. (e.g., and/or) multi-path discovery service message based on Uu RSRP. Additionally, or alternatively, a Remote WTRU 402 may determine to transmit single-path solicitation message vs. (e.g., and/or) multi-path solicitation message based on Uu RSRP. For example, the Relay WTRU 406 may transmit multipath discovery message if Uu RSRP is larger than Uu RSRP Threshold1 (e.g., a first threshold) and/or the Relay WTRU 404 may determine to transmit (e.g., transmit) single-path discovery if Uu RSRP is between Uu RSRP Threshold1 (e.g., the first threshold) and Uu RSRP Threshold2 (e.g., a second threshold). The Uu RSRP Threshold2 (e.g., the second threshold) may be used to indicate the coverage bound. The Remote WTRU 408 may transmit one or more solicitation messages for multipath. For example, the Remote WTRU 408 may transmit the one or more solicitation messages for multipath if Uu RSRP is larger than Uu RSRP Threshold2 (e.g., the second threshold) and/or the Remote WTRU 402 may transmit one or more single-path solicitation messages if its Uu RSRP is smaller than Uu RSRP Threshold2 (e.g., the second threshold) and larger than Uu RSRP Threshold3 (e.g., a third threshold). The Remote WTRU 402 and Remote WTRU 408 may be the same WTRU, for example moving further or closer to gNB 410. The Relay WTRU 406 and Relay WTRU 404 may be the same WTRU, for example moving further or closer to gNB 410.

The WTRU may determine the QoS (e.g., priority) associated with a discovery-relay-service message. The QoS (e.g., priority of the discovery message) may be determined based on one or more of a (pre-) configuration, the resource pool, and/or the type of resource pool (e.g., shared vs. dedicated) of the discovery-relay-service message. For example, the WTRU may be (pre-) configured with the priority associated with each type of discovery-relay-service message. The WTRU may (e.g., then) determine the priority of the message, for example based on the type of discovery-relay-service message the WTRU transmits. In some examples, the WTRU may be (pre-) configured with a priority associated with one or more single-path discovery-relay-service messages and/or another priority associated with one or more multi-path discovery-relay-service messages. The WTRU may (e.g., then) determine the priority of the discovery message, for example based on whether the discovery-relay-service message indicates single-path or multi-path. In another example, the WTRU may be (pre-) configured with one or more (e.g., two) priorities for a multi-path discovery-relay-service messages, for example based on whether the discovery-relay-service message is transmitted in a shared and/or dedicated resource pool. For example, if the message is transmitted in a dedicated resource pool, the WTRU may use one priority (e.g., the first priority). If the message is transmitted in a shared resource pool the WTRU may use another priority (e.g., the second priority).

The WTRU may determine one or more resource pools to transmit a discovery-relay-service message. For example, the WTRU may be (pre-) configured with one or more dedicated resource pool for discovery message and/or shared resource pool(s) with other sidelink data transmissions to transmit a discovery-relay-service message.

The WTRU may determine which resource pool and/or which type of resource pools (e.g., dedicated resource pool, or shared resource pool) to transmit a discovery-relay-service message, for example based on one or more of the following: the type of discovery-relay-service message; the QoS of the discovery-relay-service message; and/or the CBR of a resource pool.

The WTRU may determine which resource pool and/or which type of resource pools (e.g., dedicated resource pool, or shared resource pool) to transmit a discovery-relay-service message based on the type of discovery-relay-service message. For example, the WTRU may be (pre-) configured with one or more resource pools to transmit a discovery-relay-service message. Additionally, or alternatively, the WTRU may be (pre-) configured with one or more resource pools to transmit a (e.g., each) type of discovery-relay-service message. The WTRU may (e.g., then) determine which resource pool to transmit a discovery-relay-service message, for example based on the type of discovery message the WTRU is transmitting. For example, the WTRU may be (pre-) configured to use a dedicated resource pool for a single-path discovery-relay-service message. The WTRU may be (pre-) configured to use a multi-path discovery-relay-service resource pool for WTRU multi-path discovery-relay-service message. The WTRU may (e.g., then) determine which type of resource pool to transmit based on the type of discovery-relay-service message the WTRU is transmitting. For example, the WTRU may use a dedicated resource pool for a single-path discovery message and/or a shared resource pool for a multi-path discovery message.

The WTRU may determine which resource pool and/or which type of resource pools (e.g., dedicated resource pool, or shared resource pool) to transmit a discovery-relay-service message based on the QoS of the discovery-relay-service message. For example, the WTRU may be (pre-) configured with one or more (e.g., a set of) priorities to transmit a discovery message in a (e.g., one) type of resource pool. The WTRU may (e.g., then) determine which resource pool to transmit the discovery message, for example based on the priority associated with the discovery message. In some examples, the WTRU may be (pre-) configured to use a dedicated resource pool for discovery transmission having a priority of one (e.g., the highest priority). The WTRU may be (pre-) configured to use a shared resource pool for discovery transmission having another priority (e.g., priority value being greater than one/a lower priority). The WTRU may (e.g., then) determine to transmit (e.g., transmit) the discovery message in a dedicated resource pool, for example if the priority of the resource pool is one. In some examples (e.g., otherwise), the WTRU may transmit the discovery message in a shared resource pool.

The WTRU may determine which resource pool and/or which type of resource pools (e.g., dedicated resource pool, or shared resource pool) to transmit a discovery-relay-service message based on the CBR of a resource pool. For example, the WTRU may be (pre-) configured to use (e.g., either) a shared and/or a dedicated resource pool to transmit a (e.g., one) type of discovery message. Additionally, or alternatively the WTRU may be (pre-) configured to use a dedicated resource pool if the CBR of the resource pool is smaller than a threshold. In some examples (e.g., otherwise), the WTRU may use a shared resource pool. The WTRU may (e.g., then) determine whether to use the dedicated and/or a shared resource pool based on the CBR of the dedicated resource pool. For example, the WTRU may use the dedicated resource pool if CBR of the resource pool is less than a threshold. In another example (e.g., otherwise), if the CBR of the dedicated resource pool is greater than or equal to the threshold, the WTRU may use a shared resource pool. The CBR threshold may be (pre-) configured in the dedicated resource pool.

A WTRU may determine one or more transmission parameters of a discovery-relay-service message. For example, the WTRU may determine one or more of the following discovery-relay-service message transmission parameters: MCS; a transmission power; a number of subchannels used for one or more (e.g., each) transmission; a minimum, actual, and/or maximum number of retransmissions for one or more (e.g., each) message; and/or a frequency of discovery-relay-service transmission (e.g., the discovery transmission periodicity).

One or more of the discovery-relay-service message transmission parameters may be determined based on one or more of the following: the type of discovery-relay-service message; the transmission resource pool of the discovery-relay-service message; the QoS associated with the discovery message; and/or the CBR of the resource pool.

One or more of the discovery-relay-service message transmission parameters may be determined based on the type of discovery-relay-service message. For example, the WTRU may be (pre-) configured with one or more ranges of one or more transmission parameters for one or more (e.g., each) type of discovery-relay-service message. The WTRU may (e.g., then) determine the transmission parameters of the discovery-relay-service message, for example based on the type of the discovery-relay-service message. In another example, the WTRU may be (pre-) configured with a transmission power level for one or more (e.g., each) type of discovery-relay-service message. The WTRU may (e.g., then) determine which transmission power level to use based on the type of discovery-relay-service message.

One or more of the discovery-relay-service message transmission parameters may be determined based on the transmission resource pool of the discovery-relay-service message. For example, the WTRU may be (pre-) configured with ranges of one or more parameters for discovery-relay-service transmission per resource pool. The WTRU may (e.g., then) determine the transmission parameters of the discovery-relay-service message, for example based on the resource used to transmit the message.

One or more of the discovery-relay-service message transmission parameters may be determined based on the QoS associated with the discovery message. For example, the WTRU may be (pre-) configured with a (e.g., one) QoS parameter (e.g., priority) for each type of discovery message. The WTRU may be (pre-) configured in a resource pool with a range of one or more transmission parameters of a discovery message based on the QoS of the message (e.g., priority). The WTRU may (e.g., then) determine the transmission parameters of the discovery-relay-service message based on the associated QoS (e.g., priority) of the discovery-relay-service message.

The WTRU may determine information to include in one or more discovery message. For example, the WTRU may determine to include one or more of the following in a discovery message: the type of discovery-relay-service message; the set of SLRBs/LCHs and/or QoS to be supported; the maximum and/or minimum data rate; the measured Uu RSRP; the type of node (e.g., relay node vs. remote node); the minimum Uu RSRP and/or the minimum SL-RSRP/SD-RSRP; the coverage status of the WTRU; and/or the serving cell/gNB of the WTRU.

The WTRU may determine to include (e.g., transmit) the type of discovery-relay-service message in the discovery message. For example, a WTRU (e.g., Relay WTRU) may indicate the type of discovery-relay-service message in the message. The WTRU may implicitly and/or explicitly indicate which type of relay service the WTRU is offering in the discovery-relay-service message. For example, the WTRU may indicate whether it is supporting single-path-relay service, multi-path-relay service, single hop relay service, and/or multi-hop relay service. In another example, a WTRU (e.g., Remote WTRU) may indicate the type of discovery-relay-service in the message. The WTRU may implicitly and/or explicitly indicate which type of relay service the WTRU is requesting. For example, the WTRU may indicate whether it is requesting single-path-relay service, multi-path-relay service, single hop relay service, and/or multi-hop relay service.

The WTRU may determine to include the set of SLRBs/LCHs and/or QoS to be supported in the discovery message. For example, a Remote WTRU may indicate the SLRBs/LCHs and/or the QoS of the data to be supported for multi-path service. The WTRU may indicate the QoS (e.g., priority, reliability, latency) of the data triggering discovery-relay-service transmission. In another example, a Relay WTRU may indicate the SLRBs/LCHs and/or the QoS of the data to be supported for multi-path service. The WTRU may indicate the QoS (e.g., priority, reliability, latency) of the data the Relay WTRU can support.

The WTRU may determine to include (e.g., transmit) a maximum and/or minimum data rate in the discovery message. For example, a Remote WTRU may indicate its required maximum and/or minimum data rate in the discovery message, for example to support the Relay WTRU in responding to its discovery-relay-service message. In another example, a Relay WTRU may indicate its supported maximum and/or minimum data rate in the discovery message. The discovery message may be used to the Remote WTRU in performing relay (re) selection. A Relay WTRU may indicate the current and/or instantaneous data rate, for example for active relay connections at the time of discovery message transmission. The current and/or instantaneous data rate information may be used (e.g., in conjunction) with the supported maximum and/or minimum date rate of the Relay WTRU by the Remote WTRU in performing relay (re) selection.

The WTRU may determine to include (e.g., transmit) the measured Uu RSRP in the discovery message. For example, a WTRU (e.g., Relay WTRU) may indicate its measured Uu RSRP in the discovery-relay-service message. The measured Uu RSRP may be used to support the Remote WTRU in relay (re) selection.

The WTRU may determine to include the type of node (e.g., relay node vs. remote node) in the discovery message. For example, the WTRU may indicate whether it is a Relay WTRU or a Remote WTRU.

The WTRU may determine to include the minimum Uu RSRP and/or the minimum SL-RSRP/SD-RSRP in the discovery message. For example, the WTRU (e.g., Remote WTRU) may indicate the minimum Uu RSRP and/or the minimum SL-RSRP/SD-RSRP in the discovery-relay-service message, for example to establish a multi-path relay connection.

The WTRU may determine to include the coverage status of the WTRU in the discovery message. For example, a Remote WTRU may indicate whether the WTRU is in and/or out of network coverage.

The WTRU may determine to include the serving cell and/or gNB of the WTRU in the discovery message. For example, the remote and/or the Relay WTRU may indicate its cell and/or gNB in the discovery message. This indication of the cell and/or gNB may help the WTRU to prioritize the Relay WTRU supporting multipath in the same cell and/or gNB.

Relay selection may be performed. For example, a WTRU may trigger relay (re) selection. In some examples, a WTRU may trigger relay (re) selection to select the relay (e.g., by itself). The WTRU may (e.g., then) report the selected relay to the network. In another example, a WTRU may (e.g., Remote WTRU) trigger reporting the set of detected relays to the network. In some examples, a WTRU (e.g., Relay WTRU) may trigger reporting the set of detected Remote WTRUs (e.g., the set of Remote WTRUs transmitting discovery-relay-service message having SD-RSRP being greater than or equal to a threshold). A WTRU may trigger one or more of relay selection, the set of Relay WTRUs reporting, and/or the set of Remote WTRU reporting (e.g., to the network), for example based on one or more of the following: Uu RSRP being within a (pre-) configured range; a relay load; an indication from another node (e.g., gNB); and/or the arrival of data from a set of SLRBs/LCHs in the buffer or the amount of data from a set of SLRBs/LCHs being greater than or equal to a threshold.

A WTRU may trigger one or more of relay selection, the set of Relay WTRUs reporting, and/or the set of Remote WTRU reporting (e.g., to the network), for example based on the Uu RSRP being within a (pre-) configured range. For example, the Remote WTRU may trigger reporting the set of detected Relay WTRUs based on the Uu RSRP. In one example, if the Uu RSRP is within a (pre-) configured range, the WTRU may (e.g., then) report the set of detected Relay WTRUs to the network. In another example, a Remote WTRU may trigger relay selection if the Uu RSRP is within a range of thresholds.

A WTRU may trigger one or more of relay selection, the set of Relay WTRUs reporting, and/or the set of Remote WTRU reporting (e.g., to the network), for example based on a relay load. In one example, a Relay WTRU may trigger reporting the set of detected Remote WTRUs to the network if the relay load is smaller than a threshold. In another example, a Relay WTRU may trigger reporting the set of detected Remote WTRUs to the network if the relay load is larger than a threshold.

A WTRU may trigger one or more of relay selection, the set of Relay WTRUs reporting, and/or the set of Remote WTRU reporting (e.g., to the network), for example based on an indication from another node (e.g., gNB). In one example, a Remote WTRU may trigger reporting the set of detected Relay WTRUs to the network based on the request from the network. The network may request the Remote WTRU to report the set of detected WTRU (e.g., using a dedicated RRC message). The WTRU may (e.g., then) perform reporting the set of detected Relay WTRUs.

A WTRU may trigger one or more of relay selection, the set of Relay WTRUs reporting, and/or the set of Remote WTRU reporting (e.g., to the network), for example based on the arrival of data from a set of SLRBs/LCHs in the buffer, and/or the amount of data from a set of SLRBs/LCHs being greater than or equal to a threshold. For example, the WTRU (e.g., a Remote WTRU) may trigger relay selection and/or trigger reporting the set of detected Relay WTRUs to the network if the WTRU has data from a set of SLRBs/LCHs in the buffer, and/or the amount of data from a set of SLRBs/LCHs is greater than or equal to a threshold. In another example, the WTRU (e.g., Remote WTRU) may trigger (re) selection if there is a change in the status of buffered data (e.g., if the amount of data associated with a set of an existing set of SLRBs/LCHs grows). The change in the status of buffered data may be indicative of an insufficient rate of depletion of buffered data, for example due to currently selected relay. The (re) selection may be triggered by a second threshold value. Initial arrival of data from a set of SLRBs/LCHs may cause triggering and selection of a relay. Additionally, or alternatively, an increase of the data exceeding a second threshold value may trigger a (re) selection event. The (re) selection event may result in a change in the Relay WTRU selected by the Remote WTRU.

A WTRU may determine its load. The WTRU (e.g., Relay WTRU) may determine its load based on one or more of the conditions herein (e.g., the following). For example, the WTRU (e.g., Relay WTRU) may determine its load based on a channel occupancy ratio (CR) of the WTRU. In another example, the WTRU (e.g., Relay WTRU) may determine its load based on a number of connected links. The WTRU (e.g., Relay WTRU) may determine its load based on a buffer status of the WTRU. In another example, the WTRU (e.g., Relay WTRU) may determine its load based on a number of connected Remote WTRUs.

The WTRU may determine which relay to (re) select and/or which detected relay to report to the network, for example based on one or more of the following: the Uu RSRP of the Relay WTRU; the type of relay; the supported SLRBs/LCHs; the Relay WTRU supporting dual connectivity; the Relay WTRU supporting multipath in the same cell; and/or the Relay WTRU in a cell/gNB having measured Uu RSRP greater than or equal to a threshold.

The WTRU may determine which relay to (re) select and/or which detected relay to report to the network based on the Uu RSRP of the Relay WTRU. For example, the WTRU may select a relay and/or report the detected relay to the network having Uu RSRP and/or SD-RSRP greater than or equal to a threshold. The threshold may be a function of the established SLRBs/LCHs of the WTRU.

The WTRU may determine which relay to (re) select and/or which detected relay to report to the network based on the type of relay. For example, the WTRU may select and/or report the Relay WTRU supporting multi-path relay service.

The WTRU may determine which relay to (re) select and/or which detected relay to report to the network based on the supported SLRBs/LCHs. For example, the WTRU may select and/or report the Relay WTRUs supporting its established SLRBs/LCHs.

The WTRU may determine which relay to (re) select and/or which detected relay to report to the network based on the Relay WTRU supporting dual connectivity. For example, the WTRU may prioritize selecting the Relay WTRU supporting dual connectivity.

The WTRU may determine which relay to (re) select and/or which detected relay to report to the network based on the Relay WTRU supporting multipath in a (e.g., the same) cell and/or gNB. For example, the WTRU (e.g., Remote WTRU) may prioritize selecting the Relay WTRU connecting to the same cell and/or gNB with its serving cell and/or gNB.

The WTRU may determine which relay to (re) select and/or which detected relay to report to the network based on the Relay WTRU in a cell and/or gNB having a measured Uu RSRP greater than or equal to a threshold. For example, the WTRU may receive a discovery message from a Relay WTRU. The discovery message may indicate the serving cell and/or gNB. The WTRU may perform a measurement (e.g., Uu RSRP) of the serving cell and/or gNB of the relay. The WTRU may (e.g., then) prioritize the relay, for example if the measured Uu RSRP is greater than or equal to a threshold. In some examples, the WTRU may prioritize the relay having SD-RSRP greater than or equal to a threshold with the highest Uu RSRP. In another example, the WTRU may prioritize the Relay WTRU having a highest SD-RSRP with Uu RSRP of the serving cell and/or gNB greater than or equal to a threshold. The SD-RSRP and/or Uu RSRP threshold may be (pre-) configured.

The WTRU may determine which relay to (re) select and/or which detected relay to report to the network based on a distance to the gNB. For example, if the WTRU is (pre-) configured to select a single-hop relay service, the WTRU may select and/or report a Relay WTRU having distance to the gNB being within a range. The range may be (pre-) configured. Alternatively, or additionally, if the WTRU is (pre-) configured to select a multiple-path relay service, the WTRU may select and/or report a Relay WTRU having distance to the gNB being greater than or equal to a threshold (e.g., a (pre-) configured threshold). The WTRU may prioritize the one or more Relay WTRUs having a smaller (e.g., shorter) distance to the network if both relays satisfy (pre-) configured distance to the gNB conditions.

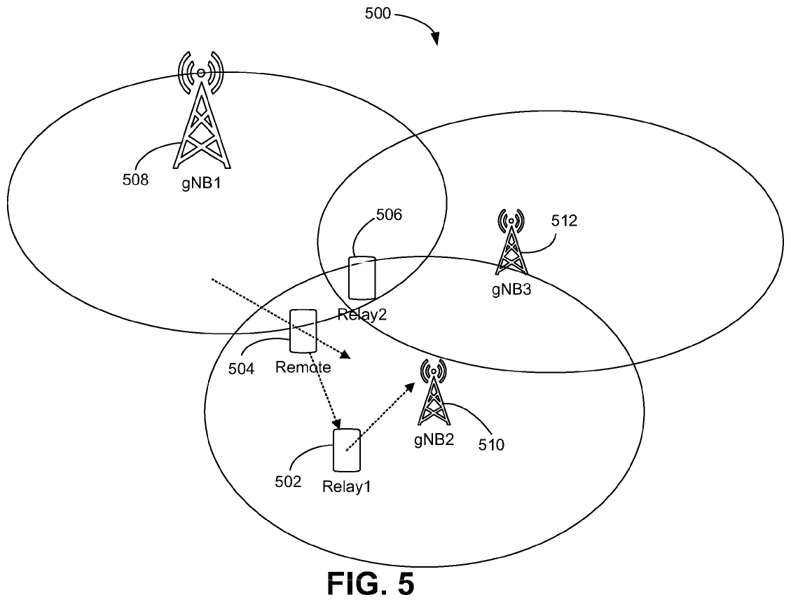

FIG. 5 illustrates an example system 500 illustrating a Remote WTRU 504 prioritizing the Relay WTRU 502 associated with the gNB 510 with measured Uu RSRP greater than or equal to a threshold. For example, as shown in FIG. 5, if the Remote WTRU 504 is going out of coverage of gNB1 508, the Remote WTRU 504 may detect Relayl 502 and/or Relay2 506. The SD-RSRP of Relay2 506 may be greater than SD-RSRP of Relayl 502. In the discovery message, Relayl 502 may indicate the ID of gNB2 510 and/or Relay2 506 may indicate the ID of gNB3 512. The Remote WTRU 504 may perform Uu RSRP measurement of gNB2 510 and/or gNB3 512. Additionally, or alternatively, the Remote WTRU 504 may determine that the Uu RSRP of gNB3 512 is less than a threshold. The WTRU may (e.g., then) prioritize selection of Relayl 502 for a multipath connection, for example with Relayl 502 and gNB2 510.

The WTRU may determine whether to perform relay reselection. In an example, the WTRU may have multi-path links to the gNB A (e.g., one) link may be a Uu link and/or another link may be a relay link. The relay link may satisfy the condition for relay reselection (e.g., one or more of: the WTRU detecting RLF with the current relay, SL-RSRP being smaller than a threshold, and/or the WTRU receiving release message from the Relay WTRU). The WTRU may determine whether to perform relay reselection based on the RRC status of the WTRU and/or the Uu RSRP.

The WTRU may determine whether to perform relay reselection based on the RRC status of the WTRU. The WTRU may perform relay reselection and/or report the set of detected relays to the network, for example if the WTRU is in RRC connected state and/or if the WTRU is in an RRC inactive state. For example, the WTRU may not perform relay reselection and/or report the set of detected relays to the network if the WTRU is in RRC idle state.

The WTRU may determine whether to perform relay reselection based on the Uu RSRP. For example, the WTRU may trigger relay reselection if Uu RSRP is smaller than a threshold. The WTRU may connect to a multi-path relay. For example, the WTRU may trigger switching to single-path relay if Uu RSRP is less than a threshold. In another example, the WTRU may trigger relay reselection if Uu RSRP is greater than or equal to a threshold. For example, the WTRU may connect to a single-path relay. The WTRU may trigger switching to a multi-path relay, for example if Uu RSRP is greater than or equal to a threshold.

The WTRU may determine whether to perform relay reselection and/or report the set of detected relays to the network. A WTRU may connect to a gNB via Uu and/or a Relay WTRU. The WTRU may detect that the current relay is no longer a preferred relay (e.g., RSRP with the current relay is less than a threshold). The WTRU may determine whether to perform relay reselection and/or inform the network of the status of the current relay based on the Uu RSRP. The WTRU may report the event to the network if Uu RSRP is greater than or equal to a threshold. For example, the WTRU may report the event to the network if it has a good Uu connection with the network. In another example (e.g., otherwise), if Uu RSRP is less than a threshold, the WTRU may perform autonomous relay reselection. The WTRU may reselect a WTRU supporting single-path relay.

Cell reselection for multipath relay may be performed. For example, a WTRU may trigger cell reselection. The WTRU may trigger cell reselection and/or report the set of detected cells to the network, or example to support the network in handover procedure. The WTRU may trigger cell reselection and/or report the set of detected cells to the network based on one or more of the following: the WTRU detects a relay having a SD-RSRP greater than or equal to a threshold; the WTRU detects a relay having SD-RSRP being an offset greater than the SD-RSRP/SL-RSRP of the current relay; and/or the SL-RSRP/SD-RSRP of the current relay and/or Uu RSRP of the current cell is less than a threshold.

The WTRU may trigger cell reselection and/or report the set of detected cells to the network based on the WTRU detecting a relay having SD-RSRP greater than or equal to a threshold. For example, the WTRU may detect a relay having SD-RSRP greater than or equal to a threshold. If the Relay WTRU is in another cell and/or gNB, the WTRU may measure Uu RSRP of the serving cell of the detected relay. The WTRU may (e.g., then) report the detected cell/gNB to the network. The WTRU may reselect the cell associated with the relay, for example if the Uu RSRP of the current gNB is less than a threshold and/or the WTRU detects Uu RLF with the current gNB

The WTRU may trigger cell reselection and/or report the set of detected cells to the network based on the WTRU detecting a relay having a SD-RSRP offset greater than or equal to the SD-RSRP and/or SL-RSRP of the current relay. For example, the WTRU may detect a relay having a SD-RSRP offset greater than or equal to a threshold. If the Relay WTRU is in another cell and/or gNB, for example, the WTRU may measure Uu RSRP of the serving cell of the detected relay. The WTRU may (e.g., then) report the detected cell and/or gNB to the network. The WTRU may reselect the cell associated with the relay, for example if the Uu RSRP of the current gNB is less than a threshold and/or the WTRU detects Uu RLF with the current gNB.

The WTRU may trigger cell reselection and/or report the set of detected cells to the network based on the SL-RSRP/SD-RSRP of the current relay and/or Uu RSRP of the current cell being less than a threshold. The WTRU may trigger relay reselection and/or cell selection, for example to select different relay and/or cell if SD-RSRP and/or SL-RSRP of the current relay is less than a threshold.

The WTRU may determine which cell to prioritize and/or report. In an example, the WTRU may trigger cell reselection and/or report the set of detected cells to the network to support the network in handover procedure. The WTRU may determine which cell to reselect and/or report to the network based on one or more of the following: the cell WTRU supporting multipath, and/or the cell/gNB having a measured SD-RSRP of a relay in the cell greater than or equal to a threshold.

The WTRU may determine which cell to reselect and/or report to the network based on the cell WTRU supporting multipath. For example, the WTRU (e.g., Remote WTRU) may prioritize selecting the cell supporting multipath. Additionally, or alternatively, the WTRU may perform (e.g., both) Uu RSRP and/or SD-RSRP measurement. The WTRU may (e.g., then) prioritize the cell having the relay in which both Uu RSRP and SD-RSRP are greater than or equal to respective thresholds.

The WTRU may determine which cell to reselect and/or report to the network based on the cell and/or gNB having measured SD-RSRP of a relay in the cell greater than or equal to a threshold. For example, the WTRU may receive a discovery message from a Relay WTRU. The discovery message may indicate the serving cell and/or gNB. The WTRU may perform a measurement (e.g., Uu RSRP) of the serving cell and/or gNB of the relay. The WTRU may (e.g., then) prioritize the cell, for example if the measured SD-RSRP is greater than or equal to a threshold. In some examples, the WTRU may prioritize the cell having Uu RSRP greater than or equal to a threshold with a highest SD-RSRP of the relay in the cell. For example, the WTRU may prioritize the cell WTRU having a highest Uu RSRP when a SD-RSRP a relay is greater than or equal to a threshold. The SD-RSRP and/or Uu RSRP threshold may be (pre-) configured.

A Relay WTRU may perform one or more discovery transmissions. For example, a WTRU (e.g., Relay WTRU) may determine one or more of which type of discovery-relay-service message to transmit, the resource pool to transmit the discovery message, and/or the parameters of the discovery-relay-service transmission. Additionally, or alternatively, the WTRU may determine one or more of which type of discovery-relay-service message to transmit, the resource pool to transmit the discovery message, and/or the parameters of the discovery-relay-service transmission based on one or more of the measured Uu RSRP of the WTRU, the relay load, and/or a relay capability.

The WTRU may receive the configuration and/or conditions for one or more (e.g., each) type of discovery-relay-service message (e.g., multi-path vs. single-path), for example via SIB or dedicated RRC. A condition may include one or more of the following: a Uu RSRP range (e.g., minimum, and maximum Uu RSRP) for single-path discovery; a (e.g., different) min_Uu RSRP for multi-path discovery-relay-service; a relay capability (e.g., which may include support single-path and/or multi-path relay); and/or the QoS (e.g., priority) and transmission resource pool for one or more (e.g., each) type of discovery message.

The WTRU may then determine which type of discovery-relay-service message to transmit based on one or more of the measured Uu RSRP, relay load, and/or the capability to support multi-path and/or single-path relay. The WTRU may select the resource pool to transmit discovery message based on the discovery type. The WTRU may use the (pre-) configured QoS of the discovery message, for example to determine the transmission parameters of the discovery message.

The WTRU may (e.g., then) indicate the following (e.g., information) in the discovery message: a discovery-relay-service type (e.g., single-path and/or multi-path); a Uu RSRP (e.g., for Remote WTRU to perform relay selection); and/or a QoS (e.g., priority) of the discovery message. The WTRU may (e.g., then) perform discovery transmission.

A Remote WTRU may perform one or more discovery-relay-service transmission. The WTRU (e.g., Remote WTRU) may determine whether to transmit a discovery message and/or the type of the discovery-relay-service message (e.g., single-path or multi-path discovery), for example based on one or more of its measured Uu RSRP, the reception of SLRB configuration for multi-path, and/or the arrival data from a set of SLRBs/LCHs in the buffer. The WTRU may perform relay selection and/or report the set of Relay WTRUs to the network, for example based on the supported relay service of the detected relay and the Uu RSRP of the Remote WTRU and/or the Uu RSRP of the Remote WTRU.

The WTRU may receive conditions (e.g., via RRC and/or SIB) to transmit one or more discovery-relay-service message. A discovery-relay-message may include one or more of a maximum Uu RSRP for single-path discovery; a range of Uu RSRP (e.g., a minimum, and/or a (different) maximum Uu RSRP) for multi-path discovery; a set of SLRBs/LCHs to trigger multi-path discovery; and/or the minimum Uu RSRP of the relay per SLRB/LCH.

The WTRU may trigger discovery transmission. For example, the WTRU may trigger a discovery transmission based on one or more of the following: the Uu threshold for transmission of multi-path discovery is satisfied; upon reception of SLRBs/LCHs configuration (e.g., which satisfies the configured conditions for multi-path relay); and/or reception of SLRBs/LCHs data (e.g., which satisfies the configured conditions for multi-path relay). The WTRU may (e.g., then) perform relay one or more response receptions. The WTRU may (e.g., then) perform relay selection and/or select the set of relays to inform the network. For example, the WTRU may (e.g., then) perform relay selection and/or select the set of relays to inform the network that satisfy one or more of the following (e.g., conditions): supporting multi-path; supporting the established SLRB/LCH; and/or Uu RSRP of the relay is greater than or equal to a threshold (e.g., which may be based on SLRB/LCH of the Remote WTRU).

The Relay WTRU may determine which set of detected Remote WTRUs to report to the network. Additionally, or alternatively, the WTRU may determine which set of detected relays to report to the network. The Relay WTRU may indicate (e.g., transmit) information in a discovery message. The Remote WTRU may indicate (e.g., transmit) its Uu connection status in a discovery-service message. A WTRU may determine to transmit the discovery-relay-service message. A WTRU may determine whether a cell supports one or more relay services. A WTRU may determine whether to transmit a discovery-relay-service message based on an indication from a cell. A WTRU may determine whether to respond (e.g., transmit) to a Remote WTRU. A WTRU may determine its load.

A WTRU (e.g., first WTRU) may monitor for one or more discovery messages. The one or more discovery messages may be from one or more second WTRUs. The WTRU may determine a set of the one or more second WTRUs, for example based on the discovery messages. The WTRU may report the set of the one or more second WTRUs, for example to a network. The set of the one of more second WTRUs may be based on a support type. The support type may include one or more of single-path service and multi-path service. The WTRU may compare a second WTRU reference signal received power (RSRP) to a threshold. The WTRU may determine the support type based on the comparison of the second WTRU RSRP to the threshold. For example, the WTRU may determine that the support type is single-path service if the second WTRU RSRP is less than the threshold. In another example, the WTRU may determine that the support type is single-path service if the second WTRU RSRP is less than the threshold. The WTRU may determine the support type based on a connection status of a second WTRU. The WTRU may compare a second WTRU quality of service (QOS) to a threshold.

A WTRU (e.g., Relay WTRU) may receive configuration information. The configuration information may indicate one or more parameters. The one or more parameters may be for operating as a WTRU-to-network mobile relay. Additionally, or alternatively, the parameters may include a first reference signal power (RSRP) threshold and/or a second RSRP threshold.

The WTRU may perform an RSRP measurement. The WTRU may perform an RSRP measurement of a serving cell, for example to determine an RSRP value. The WTRU may determine whether to indicate support for one or more of a single-path operation and a multi-path operation. The WTRU may determine whether to indicate support for one or more of a single-path operation and a multi-path operation in a sidelink discovery message, for example based on the RSRP value. The WTRU may indicate support for the multi-path relay operation based on the RSRP value satisfying the second RSRP threshold. Additionally, or alternatively, the WTRU may indicate support for the single-path relay operation based on the RSRP value satisfying the first RSRP threshold. The WTRU may transmit the sidelink discovery message, for example indicating support for one or more of a single-path relay operation and a multi-path relay operation. For example, the WTRU may transmit the sidelink discovery message indicating support for one or more of a single-path relay operation and a multi-path relay operation based on the RSRP value.

The parameters may include a relay load range. The WTRU may indicate support for the multi-path relay operation based on a current relay load of the WTRU, for example being less than a relay load range. The parameters may include an indication of a first resource pool and/or an indication of a second resource pool. The first resource pool may be for transmitting a first sidelink discovery message, for example that indicates support for the single-path relay operation. The second resource pool may be for transmitting a second sidelink discovery message, or example that indicates support for the multi-path relay operation. The sidelink discovery message may indicate the RSRP value. The WTRU may indicate support for the single-path relay operation when the RSRP value is greater than or equal to the first RSRP threshold. Additionally, or alternatively, the WTRU may indicate support for the single-path relay operation when the RSRP value is less than the second RSRP threshold.

The WTRU may indicate support for the multi-path relay operation when the RSRP value is greater than or equal to the second RSRP threshold. The WTRU may transmit a report to a network, for example based on the RSRP value. The report may indicate one or more second WTRUs. For example, the report may indicate one or more second WTRUs requesting the single-path relay operation when the RSRP value satisfies the first RSRP threshold. Additionally, or alternatively, the report may indicate one or more second WTRUs requesting the multi-path relay operation when the RSRP value satisfies (e.g., is greater than or equal to) the second RSRP threshold.

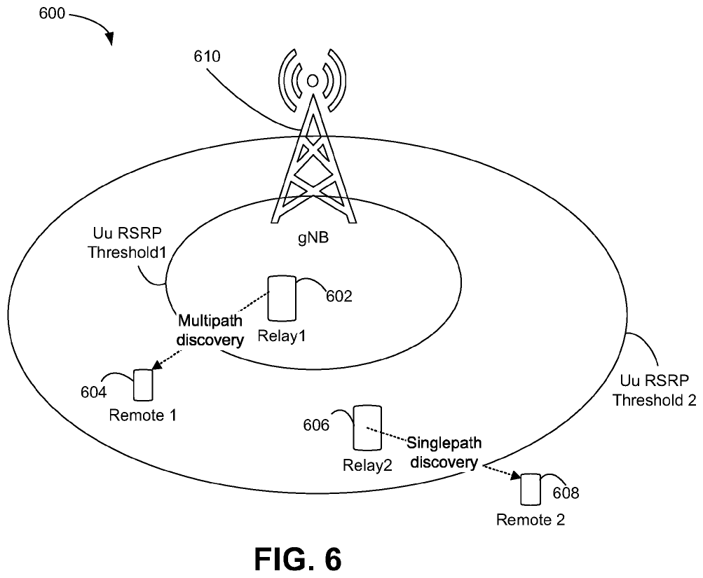

FIG. 6 illustrates an example system 600 illustrating Relay WTRU 602, 606 determining whether to transmit single-path discovery vs. multipath discovery based on measured Uu RSRP being greater than or equal to a threshold. For example, as shown in FIG. 6, Relay WTRU 602 and/or Relay WTRU 606 may receive a configuration (e.g., in SIB and/or RRC) that indicates whether to transmit single-path vs. (e.g., and/or) multi-path discovery service message, for example based on Uu RSRP. The configuration may additionally, or alternatively include a relay load to transmit multi-path discovery and/or a resource pool for multi-path discovery and/or single-path discovery. For example, the indication whether to transmit the single-path vs. (e.g., and/or) the multi-path discovery service message may additionally, or alternatively, be based on the relay load to transmit multi-path discovery and/or the resource pool for multi-path discovery and/or single-path discovery. Relay WTRU 602 and/or Relay WTRU 606 may receive the configuration from gNB 610. For example, the Relay WTRU 602 may transmit multipath discovery message if Uu RSRP is larger than Uu RSRP Threshold1 (e.g., a first threshold) and/or the Relay WTRU 606 may determine to transmit (e.g., transmit) single-path discovery if Uu RSRP is between Uu RSRP Threshold1 (e.g., the first threshold) and Uu RSRP Threshold2 (e.g., a second threshold). The Uu RSRP Threshold2 (e.g., the second threshold) may be used to indicate the coverage bound. Relay WTRU 602 and/or Relay WTRU 606 may measure Uu RSRP and/or check Uu RSRP conditions for multi-path discovery and/or single-path discovery. Relay WTRU 602 and/or Relay WTRU 606 may check the relay load condition for multi-path discovery and/or single-path discovery. Relay WTRU 602 and/or Relay WTRU 606 may transmit a single-path discovery message and/or a multi-path discovery message, for example in the (pre)-configured resource pool (e.g. if the condition(s) is satisfied). For example, Relay WTRU 602 and/or Relay WTRU 606 may indicate the discovery type (e.g., single-path and/or a multi-path) in the discovery message. The Remote WTRU 604 may transmit one or more solicitation messages for multipath. For example, the Remote WTRU 604 may transmit the one or more solicitation messages for multipath if Uu RSRP is larger than Uu RSRP Threshold2 (e.g., the second threshold) and/or the Remote WTRU 608 may transmit one or more single-path solicitation messages if its Uu RSRP is smaller than Uu RSRP Threshold2 (e.g., the second threshold) and larger than a Uu RSRP Threshold3 (e.g., a third threshold, not shown). The Remote WTRU 608 and Remote WTRU 604 may be the same WTRU, for example moving further or closer to gNB 610. The Relay WTRU 602 and Relay WTRU 606 may be the same WTRU, for example moving further or closer to gNB 610.

The processes and instrumentalities described herein may apply in any combination. Additionally, or alternatively, the processes and instrumentalities described herein may apply to other wireless technologies and/or for other services.

A WTRU may refer to an identity of a physical device and/or to a user's identity such as subscription related identities (e.g., MSISDN, SIP URI, etc). WTRU may additionally, or alternatively, refer to application-based identities (e.g., user names that may be used per application).

The processes described above may be implemented in a computer program, software, and/or firmware incorporated in a computer-readable medium, for example for execution by a computer and/or processor. Examples of computer-readable media may include, but are not limited to, electronic signals (e.g., transmitted over wired and/or wireless connections) and/or computer-readable storage media. Examples of computer-readable storage media may include, but are not limited to, a read only memory (ROM), a random access memory (RAM), a register, cache memory, semiconductor memory devices, magnetic media (e.g., but not limited to, internal hard disks and removable disks), magneto-optical media, and/or optical media (e.g., CD-ROM disks, and/or digital versatile disks (DVDs)). A processor, for example in association with software may be used to implement a radio frequency transceiver for use in one or more of a WTRU, UE, terminal, base station, RNC, and/or any host computer.

What is claimed is:

1-20. (canceled)

21. A first wireless transmit/receive unit (WTRU) comprising a processor, the processor configured to:
receive configuration information indicating parameters for operating as a WTRU-to-network mobile relay, the parameters comprising a first reference signal received power (RSRP) threshold and a second RSRP threshold;
perform an RSRP measurement of a serving cell to determine an RSRP value;
determine, based on the RSRP value, whether to indicate support for one or more of a single-path relay operation or a multi-path relay operation in a sidelink discovery message, wherein support for the multi-path relay operation is determined based on the RSRP value satisfying the second RSRP threshold, and wherein support for the single-path relay operation is determined based on the RSRP value satisfying the first RSRP threshold; and
transmit, to a second WTRU, the sidelink discovery message indicating support for one or more of the single-path relay operation or the multi-path relay operation.

22. The first WTRU of claim 21, wherein the parameters comprise a relay load threshold, and wherein the processor is configured to determine to indicate support for the multi-path relay operation based on a relay load of the first WTRU being less than the relay load threshold.

23. The first WTRU of claim 21, wherein the parameters comprise:
a first resource pool for transmitting a first sidelink discovery message, the first sidelink discovery message comprising an indication of support for the single-path relay operation; and
a second resource pool for transmitting a second sidelink discovery message, the second discovery message comprising an indication of the multi-path relay operation.

24. The first WTRU of claim 21, wherein the sidelink discovery message comprises an indication of the RSRP value.

25. The first WTRU of claim 21, wherein the processor is configured to determine to indicate support for the single-path relay operation when the RSRP value is greater than the first RSRP threshold.

26. The first WTRU of claim 21, wherein the processor is configured to determine to indicate support for the single-path relay operation when the RSRP value is less than the second RSRP threshold.

27. The first WTRU of claim 21, wherein the processor is configured to determine to indicate support for the multi-path relay operation when the RSRP value is greater than the second RSRP threshold.

28. The first WTRU of claim 21, wherein the processor is configured to determine to indicate support for the single-path relay operation and the multi-path relay operation in the discovery message.

29. The first WTRU of claim 21, wherein the processor is configured to transmit a report to a network when the RSRP value satisfies the first RSRP threshold, the report comprising an indication of one or more second WTRUs requesting the single-path relay operation.

30. The first WTRU of claim 21, wherein the processor is configured to transmit a report to a network when the RSRP value satisfies the second RSRP threshold, the report comprising an indication of one or more second WTRUs requesting the multi-path relay operation.

31. A method implemented by a first wireless transmit/receive unit (WTRU), the method comprising:
receiving configuration information indicating parameters for operating as a WTRU-to-network mobile relay, the parameters comprising a first reference signal received power (RSRP) threshold and a second RSRP threshold;
performing an RSRP measurement of a serving cell to determine an RSRP value;
determining, based on the RSRP value, whether to indicate support for one or more of a single-path relay operation or a multi-path relay operation in a sidelink discovery message, wherein support for the multi-path relay operation is determined based on the RSRP value satisfying the second RSRP threshold, and wherein support for the single-path relay operation is determined based on the RSRP value satisfying the first RSRP threshold; and
transmitting, to a second WTRU, the sidelink discovery message indicating support for one or more of the single-path relay operation or the multi-path relay operation.

32. The method of claim 31, wherein the parameters comprise a relay load threshold, and wherein the method comprises determining to indicate support for the multi-path relay operation based on a relay load of the first WTRU being less than the relay load threshold.

33. The method of claim 31, wherein the parameters comprise:
a first resource pool for transmitting a first sidelink discovery message, the first sidelink discovery message comprising an indication of support for the single-path relay operation; and
a second resource pool for transmitting a second sidelink discovery message, the second discovery message comprising an indication of the multi-path relay operation.

34. The method of claim 31, wherein the sidelink discovery message comprises an indication of the RSRP value.

35. The method of claim 31, wherein the method comprises determining to indicate support for the single-path relay operation when the RSRP value is greater than the first RSRP threshold.

36. The method of claim 31, wherein the method comprises determining to indicate support for the single-path relay operation when the RSRP value is less than the second RSRP threshold.

37. The method of claim 31, wherein the method comprises determining to indicate support for the multi-path relay operation when the RSRP value is greater than the second RSRP threshold.

38. The method of claim 31, wherein the method comprises determining to indicate support for the single-path relay operation and the multi-path relay operation in the discovery message.

39. The method of claim 31, wherein the method comprises transmitting a report to a network when the RSRP value satisfies the first RSRP threshold, the report comprising an indication of one or more second WTRUs requesting the single-path relay operation.

40. The method of claim 31, wherein the method comprises transmitting a report to a network when the RSRP value satisfies the second RSRP threshold, the report comprising an indication of one or more second WTRUs requesting the multi-path relay operation.
